(19) United States
(12) Patent Application Publication
(10) Pub. No.: US 2023/0013236 A1
(43) Pub. Date: Jan. 19, 2023

(54) Class of potentiometers and analog circuits for linearly mixing signals

(71) Applicant: Donald L Baker, Tulsa, OK (US)

(72) Inventor: Donald L Baker, Tulsa, OK (US)

(21) Appl. No.: 17/363,901

(22) Filed: Jun. 30, 2021

(51) Int. Cl. G10H 3/18; G10H 3/26

(52) U.S. Cl. CPC G10H 3/186; G10H 3/181; G10H 3/26; G10H 2220/505

(57) ABSTRACT

This invention presents a modular circuit using a 3-gang pot to mix and compensate two signals, to produce an output of approximately uniform volume. One gang, Pga, physically simulates a pseudo-sine function, Q(x), where 0≤×≤1 is fractional pot rotation. A second gang, Pgb, physically simulates a pseudo-cosine function, R(x). The circuits using Pga & Pgb multiply the two input signals by the pseudo-functions, so that the length, SQRT(Q²+R²), of vector (Q,R) stays near one. The third gang, Pgc, modifies the gain of a summer/compensator op-amp, U3, which adds the two modified signals and compensates for variations in amplitude due to phase cancellations between the two input signals, maintaining an output of near-constant amplitude. A number of embodiments consider 3-gang pots with linear, custom nonlinear and mixed tapers. Any of the three gangs may be replaced by a digital pot, driven by a programmable processor. The functions Q(x) and R(x) are also the basis for full-cycle approximate sine and cosine functions, apsin & apcos, which can be used for forward and reverse spectral transformations to predict the output of such a modular circuit from the inputs as modified by the three gangs. The modules can be cascaded or otherwise combined to add more input signals to the output. The primary application is humbucking pair signals from hum-matched single-coil electric guitar pickups, but there may be applications in other fields.

This application continues U.S. NP patent application Ser. No. 16/985,863 (Baker, filed Aug. 5, 2020), and, in regard to humbucking pair signals from matched-coil electromagnetic stringed instrument pickups, continues in part U.S. Pat. Nos. 9,401,134 (Baker, 2016), 10,217,450 (Baker, 2019), 10,380,986 (Baker, 2019), 10,810,987 (Baker, 2020), and 11,011,146 (Baker, 2021), and in part U.S. NP patent application Ser. No. 16/156,509 (Baker, filed Oct. 10, 2018), and claims the benefit of U.S. PPA 63,213,909, (2021), all filed by this inventor, Donald L. Baker dba android originals LC, Tulsa Okla., USA.

### COPYRIGHT AUTHORIZATION

Left Blank

The entirety of this application, specification, claims, abstract, drawings, tables, formulae etc., is protected by copyright: © 2021 Donald L. Baker dba android originals LLC. The (copyright or mask work) owner has no objection to the fair-use facsimile reproduction by anyone of the patent document or the patent disclosure, as it appears in the Patent and Trademark Office patent file or records, but otherwise reserves all (copyright or mask work) rights whatsoever.

### APPLICATION PUBLICATION DELAY

N/A

### CROSS REFERENCE TO RELATED APPLICATIONS

This application continues U.S. NP patent application Ser. No. 16/985,863 (Baker, filed Aug. 5, 2020), and, in regard to humbucking pair signals from matched-coil electromagnetic stringed instrument pickups, continues in part U.S. Pat. Nos. 9,401,134 (Baker, 2016), 10,217,450 (Baker, 2019), 10,380,986 (Baker, 2019), 10,810,987 (Baker, 2020), and 11,011,146, and in part U.S. NP patent application Ser. No. 16/16,509 (Baker, filed Oct. 10, 2018 ), all filed by this inventor, Donald L. Baker dba android originals LC, Tulsa Okla., USA.

### STATEMENT REGARDING REDERALLY SPONSORED RESEARCH OR DEVELOPMENT

Not Applicable

### NAMES OF THE PARTIES TO A JOINT RESEARCH AGREEMENT

Not Applicable

### INCORPORTATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENTS REGARDING PRIOR DISCLOSURES BY THE INVENTOR OR A JOINT INVENTOR

See the references cited.

### TECHNICAL FIELD

This invention describes a refinement to components and circuits disclosed in U.S NP patent application Ser. No. 16/985,863, namely potentiometers with special resistance profiles to be used in improved circuits for mixing humbucking pair signals derived from electromagnetic musical instrument vibration sensors, or pickups. The pots and circuits together produce orthogonal functions used to mix humbucking pair signals in close physical simulations of linear vector additions, and correct in part for amplitude variations due to signal phase cancellations. These pot circuits may also be of use in other fields, such as angular control and feedback in robotic and prosthetic arms.

### U.S. REFERENCES

Brigham, E. Oran, 1974, The Fast Fourier Transform, Prentice-Hall, Englewood Cliffs, N.J., 252p

U.S. Pat. No. 4,175,462, Simon, Nov. 27, 1979, System for selection and phase control of humbucking coils in guitar pickups

U.S. Pat. No. 5,140,890, Elion, Aug. 25, 1992, Guitar control system

U.S. Pat. No. 6,111,186, Krozack, et al., Aug. 29, 2000, Signal processing circuit for string instruments

U.S. Pat. No. 7,601,908, Ambrosino, Oct. 13, 2009, Programmable/semi-programmable pickups and transducer switching system.

U.S. Pat. No. 9,196, 235, Ball, et al., Nov. 24, 2015, Musical instrument switching system

U.S. Pat. No. 9,401,134, Baker, Jul. 26, 2016, Acoustic-electric stringed instrument with improved body, electric pickup placement, pickup switching and electronic circuit

U.S. Pat. No. 9,640,162, Ball, et al., May 2, 2017, Musical instrument switching system

U.S. Pat. No. 10,217,450, Baker, Feb. 26, 2019, Humbucking switching arrangements and methods for stringed instrument pickups

U.S. Non-Provisional patent application (NPPA)16/156,509, Baker, filed Oct. 10, 2018, Means and methods for obtaining humbucking tones with variable gains

U.S. Pat. No. 10,380,986, Baker, Aug. 13, 2019, Means and methods for switching odd and even numbers of matched pickups to produce all humbucking tones

Baker, Donald L., 2020, Sensor Circuits and Switching for Stringed Instruments, humbucking pairs, triples, quads and beyond, 2020, © Springer Nature Switzerland AG 2020, ISBN 978-3-030-23123-1, available at Springer dot com and Amazon dot com, 231p

U.S. NP patent application Ser. No. 16/985,863, Baker, Aug. 5, 2020, Humbucking pair building block circuit for vibrational sensors

U.S. Pat. No. 10,810,987, Baker, Nov. 20, 2020, More embodiments for common-point pickup circuits in musical instruments

U.S. Pat. No. 11,011,146, Baker, May 18, 2021, More embodiments for common-point pickup circuits in musical instruments—Part C

### BACKGROUND, PRIOR AND RELATED ART

Most of the patents in prior art dealing with electromagnetic guitar pickups address electro-mechanical switching systems, of which there are too many to cite. Even those which use digital controls for analog circuits (Simon, U.S. Pat. No. 4,175,462, 1979; Ambrosino, U.S. Pat. No. 7,601,908, 2009) are essentially switching circuits. Krozack (U.S. Pat. No. 6,111,186, 2000) is an outlier in processing the signals of separate strings with filtering circuits.

All of the background development of this invention is contained in one set of intellectual property, which is reviewed now. In U.S. Pat. No. 9,401,134 (2016), Baker disclosed a guitar with four matched single-coil pickups and a mechanical switching system which produced 10 humbucking signals. In U.S. Pat. No. 10,217,450 (2019), Baker investigated all the possible switched series-parallel combinations of single-coil pickups, with up to five pickups, and introduced the concept of a humbucking triple circuit, made of three matched pickups (FIG. 13 in U.S. Pat. No. 10,217,450). In U.S. Pat. No. 10,380,986 (2019), Baker disclosed a simplified switching system that produces all-humbucking circuits from 2 or more matched pickups, with an option for shorting one set of coils to produce standard non-humbucking single-coil pickup circuits. This approach was refined in U.S. Pat. No. 10,810,987 (Baker, 2020) and U.S. Pat. No. 11,011,146 (Baker, 2021). In U.S. NP patent application Ser. Nos. 16/156,509 (2018) and 16/985,863 (2020), and in the Springer textbook, Sensor Circuits and Switching, Baker developed and disclosed linear analog combinations of signals from humbucking pairs of matched single-coil pickups. This approach can produce the output tones of all the possible humbucking signals from mechanically switched matched pickups, as in U.S. Pat. No. 10,217,450, plus all the continuous variation in tones in between.

FIG. 1 shows Related Art, FIG. 12 in both NPPAs, an analog circuit for mixing humbucking pair signals (A-B) and (B-C) from pickups A, B & C, with circuits using a 3-gang linear pot. Note that the coils all connect to a common point, whic, h is shown as ground. If A=B=C=hum, with phases as shown by the plus signs, then the hum signals cancel at the outputs of differential amplifiers U1 and U2. But if A, B and C are string vibration signals, then the positions of the plus signs depend upon which magnetic pole in each pickup coil is toward the strings. Here we use the convention that if the North pole is toward the strings, then the overall plus sign of the string signal is on the coil terminal away from the ground. But if the South pole is toward the strings, then the overall plus sign of the string signal is on the grounded, and the negative sign is on the ungrounded terminal. So if A and C are North-up and B is South-up, then the output of U1 will be +(An+Bs) and the output of U2 will be (−Bs−Cn), or −(Bs+Cn).

The pot gang Pgc simulates a pseudo-sine function, U, which is simply a linear function from −1 at x=0 to +1 at x=1, namely, U=2x−1. The pot gangs Pga & Pgb with resistor R_{B} and the buffer, BUFF1, of gain, G, simulate a pseudo-cosine function, S, where the origin of the pseudo-cosine is taken to be the middle of the pot rotation at x=0.5. Math 1 shows the circuit equations, e1 & e2, for the circuit comprised of the resistor, R_{B} and the pot, P, with the voltages, Vc, V1 and Vw as marked in FIG. 1, with the solutions for V1/Vc and S. The gain G=(P+2*R_{B})/P, where P is the full-scale value of the potentiometer. G must be this value, so that S=1 at x=½. Math 1 duplicates Math 11 in U.S NP patent application Ser. Nos. 16/156,509 and 16/985,863.

$$e 1 : \frac{V 1 - Vc}{{R}_{B}} + \frac{V 1 - Vw}{xP} + \frac{V 1 - Vw}{( 1 - x ) P} = 0 \\ e 2 : \frac{Vw - V 1}{xP} + \frac{Vw - V 1}{( 1 - x ) P} + \frac{Vw}{xP} + \frac{Vw}{( 1 - x ) P} = 0 \\ \frac{V 1}{Vc} = \frac{2 x ( 1 - x ) P}{2 x ( 1 - x ) P + {R}_{B}} ; \frac{V 1}{Vc} {\vert}_{x = 1 / 2} = \frac{P}{P + 2 {R}_{B}} = \frac{1}{G} \\ S = G \frac{V 1}{Vc} = \frac{P + 2 {R}_{B}}{P} \cdot \frac{2 x ( 1 - x ) P}{2 x ( 1 - x ) P + {R}_{B}} \qquad Math 1$$

The plane of coefficients (S,U) describes a range of tones, due to the physical combination of signals, as in the combination, S(A+B)−U(B+C), where the variables A, B & C are taken as the signals from a North-up (N-up), a South-up (S-up) and an N-up pickup respectively. The signal for (−S,−U) is merely the inverted phase of the signal for (S,U), and the signal for (2S,2U) is merely the same as (S,U), but with an amplitude the square root of (2²+2²) times higher, or 2.828 times higher. The human ear does not easily tell the difference between a signal and its inversion, if at all. The difference tends to become more noticeable if the signal passes through a nonlinear distortion, such as a guitar pedal or tube amp, before it reaches the human ear. Ignoring any phase cancellation between the signals of A, B and C, which is addressed in this invention, the distance from the origin (0,0) to (S,U) determines the amplitude of the output signal. Therefore, requiring that (S²+U²=1) has some value. Designing electronic controls that closely simulates this relationship avoids creating duplicate tones, to which many switched pickup systems are prone. Casting out inverted signals means that we only need a half-circle in the (S,U) plane, which makes the electronics much simpler and cheaper. If necessary, the signal can always be inverted at the final output.

FIG. 2 shows related art, FIG. 13 from the prior NPPAs, which shows S and U, as generated in FIG. 1, plotted against fractional pot rotation, x, where 0<=xᵢ<=1, i=0..40 steps of 0.025. S and U are orthogonal functions, with the sum of Si*Ui, i=1.40, equal to zero within the digital accuracy of a spreadsheet calculation. The variable RSS shows the square root of (S²+U²) minus one, or err=(SQRT(S²+U²)−1). The shape of the curves can change with the values of R_{B} and P. Given the value of the more expensive pot, P, R_{B} was optimized in a spreadsheet so that the maximum deviation of err, either plus or minus, was minimized. For P=10000 ohms, R_{B} is 2923.0 ohms, with −0.0227<=err(xᵢ)<=0.0227. In a later recalculation, using slightly different order of calculating the terms in the spreadsheet, for P=10000 ohms, R_{B} is 2901.8 ohms, and maximum err is plus or minus 0.0232. The computational error due to floating point round-off has some effect.

Usually, sine and cosine are used as the orthogonal functions in this type of application, but they are hard to reproduce with simple electronics. Note S(x) in FIG. 2 looks nothing like a cosine, being much fatter at the base, with a much higher slope at x=0. FIG. 3 (Related Art, FIG. 14 from the NPPAs) shows this flaw in the plot of S vs U, where the positions of the points (U(xᵢ),S(xᵢ)) are much farther apart at the ends of the curve than they are in the middle. This distorts the effective angle of the function U(S), related to arctan(S/U)/Pi, with respect to the normalized pot rotation, x. Changes in tone can be expected to occur more rapidly at the ends of the pot rotation than in the middle. This may be acceptable, but not ideal, if nothing better can be done.

FIG. 4 shows related art, FIG. 11 from NP patent application Ser. Nos. 16/156,509 and 16/985,863, with some of the sine and cosine pot labels changed. The left side illustrates how the circuit in FIG. 1 can be scaled up to add more pickups. Note also that the input of Buff3 is [(A−B)cos(θ1)+(B−C)sin(θ1)], the input of Buff4 is [(A−B)cos(θ1)+(B−C)sin(θ1)]cos(θ2), and the input of Buff5 is (C−D)sin(θ2). This takes advantage of the trig identity, cos²(θ)+sin²(θ)=1. If A−B, B−C and C−D all have the same amplitude, then the input of Buff3 and the negative input of U4 (which is the sum of the outputs of Buff4 and Buff5), all lie a distance of 1 unit from the origin of (S,U,V)=(0,0,0), where S is cos(θ1)*cos(θ2), U=sin(θ1)*cos(θ2) and V=sin(θ2). Here, the coordinates S, U and V define the surface of half a sphere of unit radius in 3-space. You will find this in any engineering math textbook that covers coordinate transformations between rectangular and spherical coordinate spaces.

Now it may be useful to consider developed humbucking pair theory in more general terms. In general, for J number of matched single-coil pickups, J>1, there are J−1 number of possible humbucking pair signals, which can be controlled by J−2 number of dual-gang pickups, like P1 and P2 in FIG. 4. This circuit is scalable to any practical number of pickups that can be fitted on the instrument. Using pairs of scaled orthogonal functions, and ignoring amplitude variations from string signal phase cancellations, the resulting three or humbucking pair signals can be combined in a number of different ways so that they all sit on a half-sphere or half-hyper-sphere in N-dimensional space. So can the improved circuit being presented here.

$$Vo ∝ \frac{1}{K} {\sum }_{i} {a}_{i} {P}_{i} , where {a}_{i} is integer , {P}_{i} is a pickup signal and K = {\sum }_{i} \vert {a}_{i} \vert \qquad Math 2$$

In Sensor Circuits and Switching for Stringed Instruments (2020), Baker disclosed in Chapter 7 that the normalized signal output of every series-parallel pickup circuit can be expressed as in Math 2, though not in those exact terms. If K is even, then the circuit can be humbucking. If K is odd, then it cannot. If all the Pi are the same hum signal, and if K is even, then the signs of aᵢ can be arranged or changed to produce Vo=0. But this is impossible when K is odd.

If the K terms are dropped and only the summation numerator is considered, the number of distinct equations of this type for J number of matched single-coil pickups is surprisingly limited. For J=2, 3, 4 and 5, the total number of equations without considering K are 1, 2, 4 and 11, respectively. The number of equations that can represent humbucking circuits are 1, 1, 3 and 8, respectively. Things may get more complicated for six or more pickups. There are, of course, more possible circuits with different tones than the number of numerator summations, because pickups can be switched around to different positions in both the circuit and the equations. That is another story in itself

The main differences between circuits with the same numerator summation series, like the difference between series and parallel pairs of the same pickups, are the signal amplitude and lumped circuit impedance, which interacts differently with the same tone circuit. So if circuits with the same summation series feed directly into a preamp with a high input impedance without any tone circuits, they may have different amplitudes, but will have the same spectral and tonal content. The human ear is nonlinear and may perceive the same signal at different amplitudes as different tones.

$$Vo ∝ {\sum }_{i = 1}^{n} {a}_{i} {P}_{i} = {\sum }_{i = 1}^{n - 1} {b}_{i} ( {P}_{i} - {P}_{i + 1} ) , or {a}_{1} {P}_{1} + {a}_{2} {P}_{2} + … + {a}_{n} {P}_{n} = {b}_{1} ( {P}_{1} - {P}_{2} ) + {b}_{2} ( {P}_{2} - {P}_{3} ) + … + {b}_{n - 1} ( {P}_{n - 1} - {P}_{n} ) , \\ where {P}_{i} is a pickup signal and \\ ( {P}_{i} - {P}_{i + 1} ) is a humbucking pair signal \qquad Math 3$$

$${a}_{1} = {b}_{1} , {a}_{2} = {b}_{2} - {b}_{1} , {a}_{3} = {b}_{3} - {b}_{2} , … , {a}_{n - 1} = {b}_{n - 1} - {b}_{n - 2} , {a}_{n} = - {b}_{n} \\ {b}_{1} = {a}_{1} , {b}_{2} = {a}_{2} + {b}_{1} = {a}_{2} + {a}_{1} , … , {b}_{j} = {\sum }_{j = 1}^{i} {a}_{j} , … , {b}_{n - 1} = - {a}_{n} \qquad Math 4$$

$$\begin{matrix}⇒ {b}_{n - 1} = {a}_{1} + {a}_{2} + … + {a}_{n - 1} = - {a}_{n} \\ ⇒ {a}_{1} + {a}_{2} + … + {a}_{n - 1} + {a}_{n} = 0\end{matrix} \qquad Math 5$$

Now consider Math 3, 4 & 5. First remember that humbucking circuits do not depend upon which magnetic pole is up or which way a pickup coil is wound. If all of the pickup magnets were suddenly de-magnetized, a proper humbucking circuit would still be humbucking. If a coil were actually reverse-wound, the effect of the reverse winding could be nullified by reversing the coil terminals. Let Pi be a pickup signal, and consider that it is a string vibration signal implicitly multiplied by +1 for an N-up pickup, and by −1 for an S-up pickup. And if there are no vibrating strings, then consider it to be a hum signal. If Pᵢ are all the same hum signal and all the aᵢ sum to zero, then the series in Math 3 describes a humbucking circuit.

Math 3 shows how the summation in Math 2 corresponds to the summation of a set of (n−1) humbucking pair signals, (Pᵢ−Pᵢ₊₁) with coefficients, bᵢ. Math 4 shows how all the individual coefficients a, relate the coefficients bᵢ. Math 5 solves Math 4 for the individual coefficients bᵢ in terms of aᵢ, demonstrating that the solution for bₙ₋₁ proves that the sum of the aᵢ coefficients is zero, fully consistent with a humbucking circuit. So for every humbucking set of aᵢ, there is a humbucking set of bᵢ, showing that every series-parallel humbucking circuit can be expressed as a linear sum of humbucking pair signals.

Now consider FIG. 4 again. Ignoring differences in signal amplitude and lumped impedance, the spectral output of all the series-parallel humbucking circuits that exist in switched circuits exist as discrete points on the rotation of the pot gangs forming the orthogonal functions. FIG. 4 not only produces all the humbucking tones that can be made from series-parallel switched circuits, but all the continuous tones in between.

### SUMMARY OF INVENTION

This invention simplifies the circuit in FIG. 1, FIG. 12 from NP patent application Ser. No. 16/985863, which produces two orthogonal functions from a 3-gang linear potentiometer, used in the vector addition of humbucking pair signals. It adds a following section to adjust output for signal amplitude variations due to phase cancellations in signals combined from two or more pickups. And it modifies the resistance profile, or taper, of the potentiometer gangs involved to provide both better amplitude compensation for phase cancellations and a more linear relation of the pot fractional rotation angle to the angle related to the arc-tangent of the two orthogonal functions that the circuit produces. This new approach takes the same three gangs of a pot, and moves one of two gangs that produce a pseudo-cosine function to the added following section that compensates for amplitude variations due to signal phase cancellations.

### Technical Problems Found and Resolved

The previous circuit in this set of intellectual property in stringed instrument, which linearly combines two humbucking pair signals, did not adjust for phase cancellations between the signals, which affect the final output. Nor did the angle generated by the orthogonal functions, S(x) and U(x), related to arctan(S/U), change linearly with x, producing potentially faster tonal variations at the ends of the pot rotation that in the middle. This second part may or may not be a practical problem for the user, but it is not intellectually satisfying. Further, the part of the circuit that produces the pseudo-cosine function, U(x), with pot rotation, x, is more complicated than necessary, using two gangs on a pot instead of just one. The same three pot gangs, either with linear or modified resistance tapers, can be used both to produce orthogonal functions for signal mixing, and to compensate for amplitude variations due to phase cancellations.

### BRIEF DESCRIPTION OF THE DRAWINGS

FIG. 1 shows related art from NP patent application Ser. No. 16/985,863 (FIG. 12), the circuit being improved. Humbucking pair signals are generated by 3 hum-matched pickups, A, B & C and two differential amplifiers, U1 and U2. Gang Pgz of pot P produces a pseudo-sine signal, U(B−C), from the output of U2. Resistor R_{B}, pot gangs Pgb & Pgc, and Buff1 of gain, G, form together a pseudo-cosine signal, S(A−B). The humbucking pair signals U(B−C) and S(A−B) are linearly combined in the summer circuit made with op-amp U3, then passed to the output via volume pot P_{VOL}.

FIG. 2 shows related art from NP patent. application Ser. No. 16/985,863 (FIG. 13), the functions U(x) and S(x) cited in FIG. 1, where x is the fractional rotation of pot gangs Pga-c. RSS is (SQRT(S(xᵢ)²+U(xᵢ)²)−1), the unit radius error from (0,0) to (U,S) in the US-plane, where xi are 40 steps of 0.025 from x=0 to x=1.

FIG. 3 shows related art from NP patent application Ser. No. 16/985,863 (FIG. 14), the track of (Ui,Si) points generated from FIG. 2, showing that distortion in US-plane step length due to using linear taper gangs in pot P.

FIG. 4 shows related art from NP patent application Ser. No. 16/985,863 (FIG. 11), an example of scaling the invention in 16/985,863 from 3 to 4 single-coil pickups, using two pots with sine and cosine gangs, instead of the approximation pseudo-functions in FIG. 3.

FIG. 5 shows the improved circuit, which simplifies the pseudo-cosine circuit from FIG. 1, where the cosine humbucking pair signal is now R(A−B) and the sine humbucking pair signal is now Q(B−C). It removes Pgc one of the two gangs previously used after U1, and moves Pgc to the summing circuit about U3, to form a variable-gain circuit with R₁, R₂ and R_{F}, to compensate for variations in the amplitude of R(A−B)+Q(B−C) due to phase differences between the pickups, A, B & C. In this configuration, the summer gain is a minimum when the wiper of Pgc is centered (x=½). R₁ and R₂ set the gains at pot rotation x=0 and x=1.

FIG. 6 is the same circuit as FIG. 5, but for the revised feedback circuit about U3 setting the maximum gain at x=½.

FIG. 7 shows the Q(x) pseudo-sine function and R(x) pseudo-cosine function, plotted against the left axis, generated by linear pot gangs in FIGS. 5 & 6, with the radius and rotational errors plotted against the right axis, when the RSS radius error is minimized as an objective function, using the value of resistor R_{B} as a fitting parameter. The horizontal axis, x, is the fractional pot rotation.

FIG. 8 shows the same plots when the extreme radius error is used and minimized as an objective function. Some changes from FIG. 7 are visible in the error plots.

FIG. 9 shows plots of the mean frequency (left axis) and relative amplitude (right axis) of the humbucking pair, Q(x)(N−B)+R(x)(M+N), plotted against fractional pot rotation, x, using known measured points of switched humbucking pairs from Table 2. This is twice the expected input at the plus input of U3 in FIGS. 5 & 6.

FIG. 10 shows the same plot as FIG. 9, but against QRrot, the fractional clockwise rotation of (Q,R) in the QR-plane.from (Q,R)=(−1,0), calculated from arctan(R/Q)/Pi. This shows how the plots would look if the pot gangs, Pga & Pgb, had true sine and cosine tapers instead of the physically-simulated pseudo-functions.

FIG. 11 plots the FIG. 5 circuit values for Vhb=Q(x)(N−B)+R(x)(M+N), the Gain of the summer/compensator circuit using U3, and the output, Vo, of U3 against fractional pot rotation, x, for linear taper pot gangs. It shows the difficulty of compensating for amplitude variations due to signal phase cancellations, when one of the six combinations of humbucking pairs and Q and R is randomly chosen and does not fit well to the gain curve that the summer/compensator can produce.

FIG. 12 plots the known measured points of the mean frequencies of switched humbucking signals in Table 2 for the six combinations of Q, R and humbucking pairs in Tables 4 & 16.

FIG. 13 plots the known measured points of the relative amplitude of switched humbucking signals in Table 2 for the six combinations of Q, R and humbucking pairs in Tables 4 & 16.

FIG. 14 plots Vhb, Gain and Vo for FIG. 5 and Vhb=Q(x)(N−B)+R(x)(M+B), showing a relatively successful match of relative amplitude shape to gain shape, compared to FIG. 11, using linear taper pot gangs.

FIG. 15 plots Vhb=Q(x)(M+B)+R(x)(N−B), Gain and Vo for FIG. 6, using linear pot gangs, showing the second best fit of summer/compensator gain, compared to FIG. 14.

FIG. 16 shows another plot similar to FIGS. 7 & 8, fitting linear pot tapers according to Maths 7 & 8, using the circuits in FIGS. 5 & 6, where the Objective Function minimized is SUMSQ(RadErrᵢ)+MAX(RotErrᵢ)+ABS(MIN(RotErrᵢ), i=0, 40, in Table 18, where RadErr is the radius error, RotErr is the rotational error, calculated for 40 steps of 0.025 in fractional linear pot rotation, xᵢ, from x=0 to 1. In addition the linear pot taper, f(x)=x, used to generate Q(x)=2f(x)−1, and the QR-plane rotational angle, QRrot, are plotted against the left axis. RadErr and RotErr are plotted against the right axis. The deviation of QRrot from x is clearly visible.

FIG. 17 plots the same variables as FIG. 16, except that f(x) is the fitted piecewise-quadratic according to Math 14, as fitted in Table 18.

FIG. 18 modifies the circuit in FIG. 5 to use a pot gang Pgb with a center-tap input, eliminating the fitting resistor R_{B}, and the Gain, in Buff2. In this embodiment, linear tapers will not work properly in pot gangs Pga & Pgb. The tapers must be nonlinear to produce either sine and cosine or useful pseudo-functions to approximate them.

FIG. 19 shows the graphic results, for xᵢ=0 to 1 in steps of 0.025, i=1, 40, where Rcd is as described in Math 19, g-cd is described as g(x) in Math 18, f-ab is described as f(x) in Maths 13 & 14, Qab=Q(x)=2*(f(x)−½), RadErr is the radius error, (SQRT(Q(x)²+R(x)²)−1), and RotErr is the rotation error, (QRrot−1), where QRrot is as defined in Math 9.

FIG. 20 shows the summer/compensator gains calculated from Math 11, M11 Gain, and Math 12, M12 Gain, using linear pot tapers in FIGS. 5 & 6, for P=1 (scaled), R1=0.15, R2=0.2, and RF=0.7 for Math 11 and RF=0.08 for Math 12. M12 Gain is an upside-down parabola, and M11 Gain is a slightly flattened parabola, where the influence of R₁ can be seen at x=0, and the influence of R₂ can be seen at x=1. The maxima and minima tend to remain in the center.

FIG. 21 shows the plot for the summer/compensator M11 Gain and M12 Gain against left axis with f(x) against the right, versus the fractional pot rotation, x. The M11 Gain and M12 Gain are calculated by substituting f(x) for x in Math 11 and Math 12, respectively, and are used in the summer/compensator circuits for FIGS. 5, 6, 18 & 26. In this curve, the fitting parameter is a₁=0.20527 from f(x) in Math 14.

FIG. 22 shows a similar plot with the fitting parameter a₁=0.16709 in f(x).

FIG. 23 plots a similar set of curves for g(x) in Math 20, with a₁=0.16709.

FIG. 24 replots FIG. 12 using the QRrot(x) reverse transformation in Table 21 for FIGS. 5 & 6, using P=1, R_{B}=0.163391 and a₁=0.205727. This shows the distribution of the mean frequencies of the six Q-R-humbucking pair combinations, when QRrot more closely approaches x.

FIG. 25, like FIG. 24, replots the relative amplitudes in FIG. 13 using Table 21

FIG. 26 shows the adaptation of FIG. 6, using a Pgb pot gang with a center-tapped input, much like FIG. 18 does FIG. 5.

FIG. 27 shows a simplified circuit for pot gang Pgc in FIGS. 5, 6, 18 & 26, where R₁ and R₂ are combined in a single resistor, R₁.

FIG. 28 shows the exact fit of the resistance profile of Pgc in FIG. 18, for the input of [Q(x)(N−B)+R(x)(M+B)]/2 at the plus input of U3, to produce a constant amplitude output at Vo for the seven measured points in Table 11.

FIG. 29 shows the exact fit of the resistance profile of Pgc in FIG. 26, for the input of [Q(x)(M+B)+R(x)(N=B)]/2 at the plus input of U3, to produce a constant amplitude output at Vo for the seven measured points in Table 12.

FIG. 30 is related art, FIG. 25 in NP patent application Ser. No. 16/985863, showing how each pickup can have a traditional tone circuit, for those who wish that kind of control. It also follows from FIGS. 9-11 in U.S. Pat. No. 10,380,986.

FIG. 31 is related art, FIG. 23 in NP patent application Ser. No. 16/985,863, from which this invention continues. It replaces U1 in FIGS. 5, 6, 18 & 26 with two op-amps, U1 and U2, forming a differential amplifier. It replaces pot gang Pgb in those figures by a digital pot, P_{DC/S}, and a replaces the circuit using R₁, R₂ and pot gang Pgc about the summer/compensator amplifier, U3, with a digital pot, P_{DF}.

FIG. 32 shows basic polynomial functions, based on Math 33, for a fitting parameter a₁=0.15, used to approximate one-quarter each of approximate sine and cosine functions, versus the normalized independent variable, x=2 theta/pi.

FIG. 33 shows the approximate sine and cosine functions, APSIN and APCOS, developed from the second-order polynomials in Math 33-34 for a fitting parameter a1=0.15.

FIG. 34 shows the approximate functions APSIN and APCOS, plotted against the left axis, with their sine and cosine errors plotted against the right axis, for Math 33-36.

FIG. 35 shows the approximate functions APSIN and APCOS, and their errors, for the fourth-order polynomials in Math 38-39.

### DESPRIPTION OF THE INVENTION

Writing this Specification like an engineering tutorial has several purposes: 1) it fulfills the mandate of patents to provide enough information to recreate the invention; 2) it assures potential licensees that the invention has been thoroughly engineered and justified; and 3) it makes it harder for patent trolls and infringers to dispute or misappropriate the work.

### Necessary Data Obtained from Three P-90 Style Pickups

In U.S. Pat. No. 10,380,986 (2019) and U.S. Pat. No. 10,810,987 (2020), Baker disclosed that three matched single coil pickups switched in a simple circuit can produce three humbucking pairs and three humbucking triples. If we take an N-up pickup next to the neck of a standard-sized electric guitar, Nn, another N-up pickup next to the bridge, Bn, and an S-up pickup midway between them, Ms, we may call the string vibration signals, N, −M and B, respectively. The available switched humbucking signals are: N−B, N+M, M+B, N+(M−B)/2, B+(M−N)/2 and M+(N+B)/2, or any of their inverts, which are not counted here as separate tonal signals.

For this experiment we need a measurement of tone, even a crude one. Tone is commonly held to be very subjective in the human ear, and this inventor is not aware of any recognized physical measures. So here we will use the mean frequency of six strings on a prototype guitar, tuned to the standard EADGBE, and strummed individually in the sequence, 6-5-4-3-2-1-6-5-4-3-2-1, one-half to one second between picks, open fret, midway between the neck and the bridge. The spectral amplitudes are obtained by feeding the circuit output into a computer microphone input while running a shareware Fast Fourier Transform (FFT) program, Simple Audio Spectrum Analyzer v3.97c, © W. A. Speer 2001-2016, www_dot_techmind_dot_org. The program was used with the following settings:

TABLE 1
Settings for SpecAn_3.97 c

| | |
|---|---|
| Amplitude scale | 135 db Logarithmic; Zero-weighted |
| Frequency scale | Logarithmic |
| Mixer | Mic input 100% |
| Visualization | Spectrograph with average |
| Sample rate | 16 kHz |
| FFT size | 4096 |
| FFT Window | Hanning (raised cosine) |

This produced 2048 frequency bins of about 4 Hz each, from 0 to 7996 Hz. The export files in MSDOS txt format had headers giving the sample rate, number of windows of 4096 samples and total length of the signal in seconds (i.e., 139 windows, 17.792 second), notation of the Hanning window used, and zero-weighting. There followed two columns of comma-separated data, the frequency of the FFT bin in Hz, fₙ, and the average amplitude of the signal, S₁, in each bin in dBFS, or the decibels as related to the full scale of the computer sound board input at zero dB.

$$lin {V}_{n} ( {f}_{n} ) = {10}^{{S}_{n} / 20} , 1 \leq n \leq 2048 \\ {P}_{V} ( {f}_{n} ) = \frac{lin {V}_{n}}{{\sum }_{n = 1}^{2048} lin {V}_{n}} \\ mean . f = {\sum }_{n = 1}^{2048} {f}_{n} * {P}_{V} ( {f}_{n} ) \\ 2 nd . moment . f = {\sum }_{n = 1}^{2048} {( {f}_{n} - mean . f )}^{2} * {P}_{V} ( {f}_{n} ) \\ 3 rd . moment . f = {\sum }_{n = 1}^{2048} {( {f}_{n} - mean . f )}^{3} * {P}_{V} ( {f}_{n} ) \qquad Math 6$$

Math 6 shows the calculations made in a spreadsheet program from those data. First Sₙ, is converted from exponential dB data to a linear relative voltage, Vₙ. Probability function of the spectrum, Pᵥ(f₁), is calculated by dividing each bin signal voltage by the total of all the bin voltages. Said another way, this is the relative strength of each bin signal compared to the total signal. Then the mean frequency, mean.f, is calculated by multiplying the frequency of each bin by the relative strength of each bin. Higher moments are calculated as shown, but are presentations here as the square root of the second moment and the cube root of the third moment, so that both will be in dimensions of frequency (Hz). This was done for a total of 6 humbucking pickup combinations, shown in Table 2

TABLE 2
Spectrum Analysis Outputs for Humbucking
Signals, ordered by frequency.

| | | | Square | Cube |
|---|---|---|---|---|
| | | | Root of | Root of |
| Humbucking | Relative | Mean | Second | Third |
| Signal | Amplitude | Freq (Hz) | Moment | Moment |
| N − B | 0.80 | 862.3 | 929.4 | 1352.6 |
| B + (M − N)/2 | 1.27 | 677.1 | 721.3 | 1125.3 |
| N + (M − B)/2 | 0.91 | 645.4 | 793.4 | 1221.5 |
| M + B | 1.56 | 588.6 | 709.6 | 1185.4 |
| N + M | 1.11 | 518.7 | 709.1 | 1218.8 |
| M + (N + B)/2 | 1.49 | 509.0 | 606.1 | 1057.6 |

The fact that the out-of-phase humbucking pair (N−B) has the highest mean frequency and the lowest relative amplitude is not surprising. Nor is the fact that all the circuits with the highest mean frequencies also have out-of-phase signals. And the humbucking signals with all the pickups in-phase have the lowest mean frequencies. The relative amplitudes range from 1.56 to 0.80, a factor of 1.95 to 1. It is not clear to this inventor how the root second and third moments can be used, so they will be ignored. Clearly, more work needs to be done on defining usable physical measures of tone.

### Modified Circuit with a Linear 3-Gang Pot

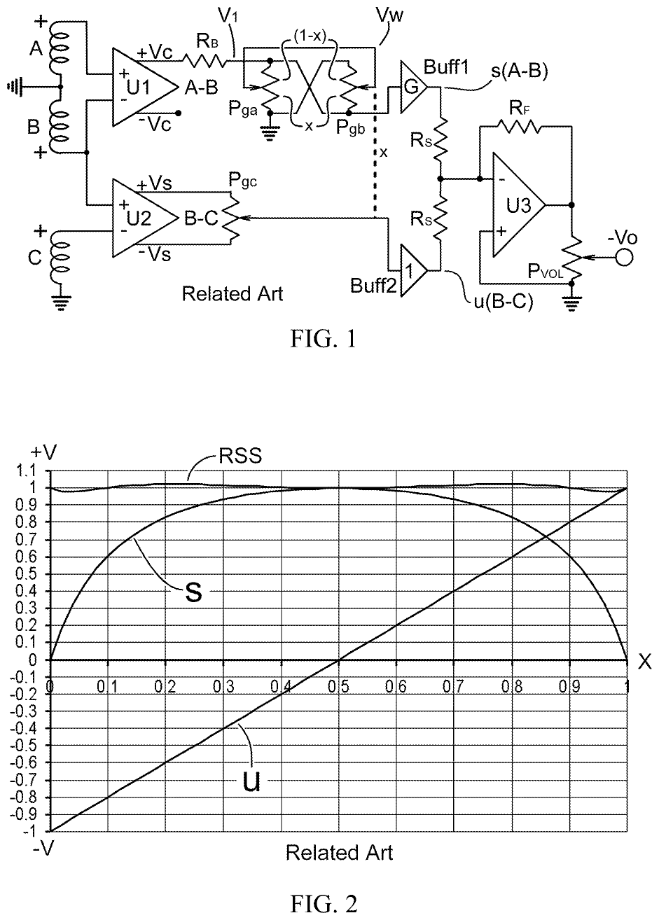

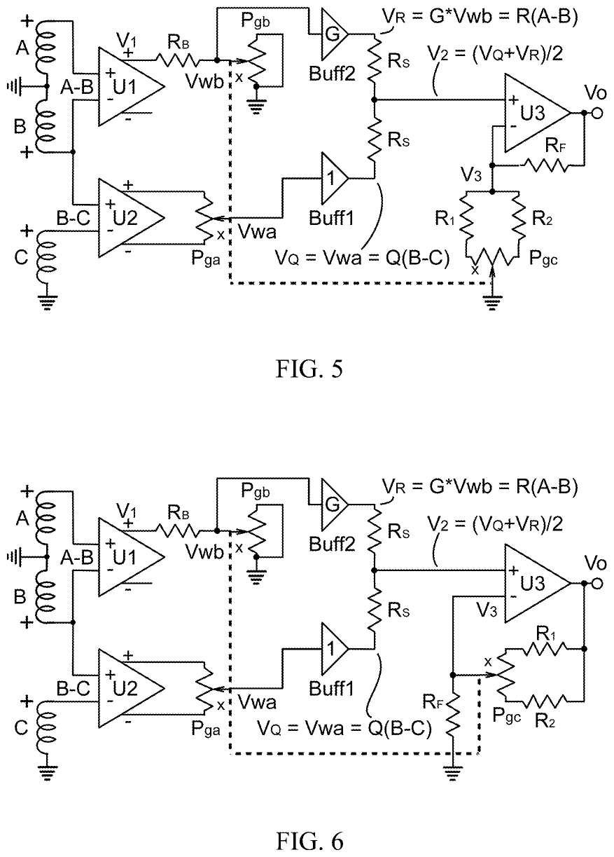

FIGS. 5 & 6 show one part of the invention in the improved version of FIG. 1. The three gangs of pot, P, have been renamed and moved about. Here, we change some nomenclature. The pseudo-sine function is now Q(x), and the pseudo-cosine function is now R(x), where x is the fractional pot rotation. FIGS. 5 & 6 differ only in the output feedback stage, U3, where it has a minimum output gain in FIG. 5 when pot gang Pgc is centered in its rotation, and a maximum output gain in FIG. 6 when pot gang Pgc is centered in its rotation.

We take A, B & C to indicate both the pickups and their signals. The plus signs on the coils again indicate the relative hum phase, to emphasize that the circuits are humbucking. The plus signs also indicate relative string vibration signal phases when the pickups are N-up. When a pickup is S-up, the string signal phase is reversed. In both Figures, the fully-differential amplifiers, U1 & U2, should have gains of 2, so that the plus output of U1 is V1=(A−B), the plus output of U2 is (B−C), and the minus output of U2 is −(B−C). We start with the case of a linear pot, P, with three gangs, Pga, Pgb and Pgc. The pot gang a, Pga, forms the pseudo-sine signal on the wiper voltage, Vwa, according to Math 7. The output of the buffer, BUFF1, with a gain of one, is V_{Q}=Vwa=Q(x)(B−C)=(2x−1)(B−C) for a linear pot. As before, the origin of the function Q(x) is at x=½, making it a pseudo-sine function instead of pseudo-cosine.

Vwa=(2x−1)(B−C)=Q(B−C) Math 7:

where 0≤x≤1, the fractional pot rotation

$${e 1 : \frac{V w b - V 1}{{R}_{B}} + \frac{V w b}{x P} + \frac{V w b}{( 1 - x ) P} = 0 solving e 1 : \frac{V w b}{V 1} = \frac{x ( 1 - x ) P}{x ( 1 - x ) P + {R}_{B}} , where \frac{Vwb}{V 1} \vert}_{x = 1 / 2} = \frac{P}{P + 4 {R}_{B}} ⇒ G = \frac{P + 4 {R}_{B}}{P} , and R ( x ) = G \frac{V w b}{V 1} = \frac{x ( 1 - x ) ( P + 4 {R}_{B} )}{x ( 1 - x ) P + {R}_{B}} , where R ( 0 ) = 0 , R ( 1 / 2 ) = 1 , R ( 1 ) = 1 \qquad Math 8$$

Resistor, R_{B}, pot gang b, Pgb, and buffer, BUFF2, with a gain of forms the pseudo-cosine function, R(x). In the case of a linear pot, where the pot taper is f(x)=x, Math 8 shows the solution. With a linear taper, the counter-clockwise end of pot rotation is usually taken to be x=0, with the clockwise end at x=1. Therefore the resistance of pot P, of value P ohms, between the counter-clockwise end and the wiper is x, and between the wiper and the clockwise end is (1−x). The equation e1 in Math 8 is the circuit equation by the rule that all current which flows into a node must also flow out, since nodes can neither generate nor sink current.

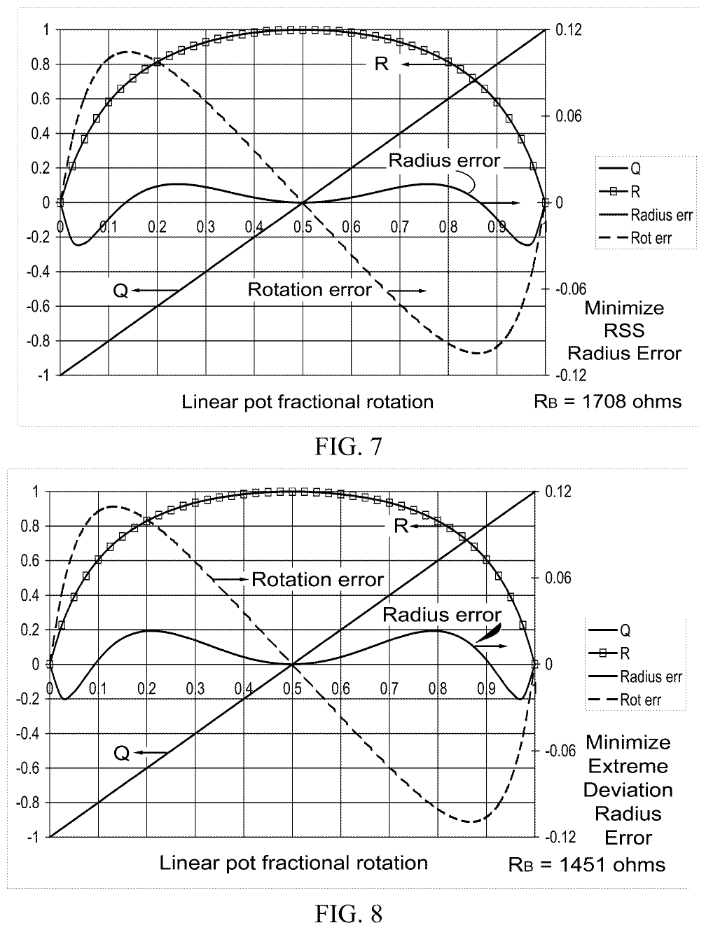

As before, Q(x) is a fixed linear function, but the shape of R(x) can be changed slightly by changing the resistance value of wither R_{B} or P. Since the pot is relatively expensive, with many fewer values to choose, we fix it for this exercise at 10 kΩ. Here, we minimize one of two measures of the deviation in the radius of (Qi,Ri) in the Q-R-plane, errᵢ=SQRT(Qi²+Ri²)−1, over all the values xᵢ for which they are calculated from Math 8. Most computer spreadsheets have an optimizing tool such as “Solver” or “What If”, that will minimize an objective function on one or more parameters, such as R_{B}. FIG. 7 shows the plots for minimizing an objective function of the root-sum-square of err in a spreadsheet, over 41 consecutive values of xᵢ, where xᵢ=0, 0.025, . . . , 1, xᵢ−xᵢ₋₁=0.025, i=0, . . . , 40, which is RSS=SQRT(SUMSQ(err₁, . . . , errₙ)=0.078503, resulting from R_{B}=1451 ohms.

FIG. 8 shows the plots for minimizing the maximum extreme deviation of the radius error, or MIN(MAX(err₁, . . , err₁), −MIN(err₁, . . . , errₙ))=0.023185, resulting from R_{B}=1708 ohms. Q(xᵢ) and R(xᵢ) are plotted against the left-hand vertical axis, and two errors are plotted against the right-hand vertical axis, the previously-defined radius error, errᵢ, and the rotational error, roterrᵢ as defined in Math 9.

$${QRrot}_{i} = \{ \begin{matrix}1 - \frac{1}{π} ( π + arctan ( \frac{R i}{Q i} ) ) , Qi < 0 \\ 0.5 , Qi = 0 \\ 1 - \frac{1}{π} arc tan ( \frac{R i}{Q i} ) , Q i > 0\end{matrix} r o t e r {r}_{i} = Q R r o t ( {x}_{i} ) - {x}_{i} \qquad Math 9$$

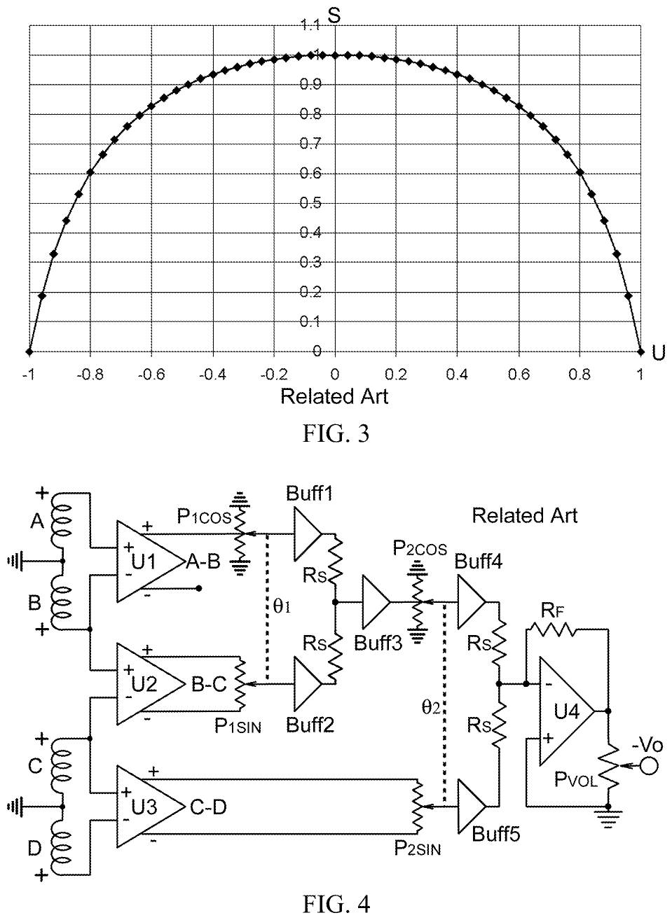

Here we have defined Q(x)=2x−1, with Q(0)=−1, Q(½)=0 and Q(1)=1, with R(x)≥0. So the rotation of (Q(x),R(x)) through the QR-plane starts at (−1, 0), goes clockwise, and ends at (1, 0), the opposite of the standard mathematical angle, which is zero at (1, 0) and goes counter-clockwise. This explains the “1−” in Math 9. The arctangent is defined in the right-half plane or (Q,R), not the upper-half, so the adjustment to get it there is necessary for Qi<0. Also the arctangent is not defined for Q=0, when (Q,R)=(0,1), so the value of ½ is entered. QRrotᵢ is the normalized rotational angle in the (Q,R)-plane, measured clockwise from (Q,R)=(−1, 0), calculated as if (Q,R) were a point in the (x,y)-plane. Because Q and R are not sine and cosine, QRrot is not x, but approximates x. It is distorted from x, as shown in the positions of the 40 points on the graph of R(xᵢ) in FIGS. 7 & 8. As before in FIG. 3, this shows that the real separation of continuous tones with pot rotation is greater at the ends and less in the middle, compared to the case where the Q and R are sine and cosine. Note that rotational error is symmetrical in both the vertical and horizontal in the plots, but radius error is only symmetrical in the horizontal.

TABLE 3
Results of values of R_{B}. Where RB is in ohms, followed by
the Root-Sum-Square of the radius errors, (SQRT(Q(xᵢ)² +
R(xᵢ)²) − 1), the minimum radius error, the maximum
radius error and the extreme limits of the rotational error.

| | RSS | Min | Max | Rotation |
|---|---|---|---|---|
| R_{B}(Ω) | radius err | rad err | rad err | err |
| 1451 | 0.0948 | −0.0232 | 0.0232 | ±0.1093 |
| 1500 | 0.0891 | −0.0240 | 0.0209 | ±0.1083 |
| 1708 | 0.0785 | −0.0283 | 0.0128 | ±0.1044 |

Table 3 shows the results of the error measures for R_{B}=1451, 1500 and 1708 ohms. They are not all that different. For R_{B}=1451 ohms, the minimized maximum deviation of radius error is ±0.0232, and the RSS radius error is the largest at 0.0948. For R_{B}=1708 ohms, the RSS radius error is 0.0785 and the maximum deviation in radius error is −0.0283, but the separation of deviation errors is 0.0411 instead of 0.0464. The average of 1451 and 1708 is 1579.5 ohms, and 1500 ohms is the closest 10% tolerance value. As the table shows, it makes a reasonable compromise.

### Calibrating Buff2 Gain

There may be more latitude in setting R_{B} than the gain, G (Math 8), of Buff2 in FIGS. 5 & 6. The form of Buff2 was not previously specified, but it should be some high-input-impedance amplifier with a moderately variable gain. When the pot gang, Pgb, is set to center position, G should be adjusted until its output voltage, V_{R}, is equal to the output voltage of U1, V₁. Once set in the manufacture of the circuit, it may nor may not need to be set again. Farther along, this Specification presents an alternative pot gang, with a center-tapped input and a nonlinear tapter, that eliminates this step.

### Humbucking Pair Signals with a Linear 3-Gang Pot

The variable-gain summing circuit about op-amp U3 in FIGS. 5 & 6 uses the third gang, Pgc, in either leg of the feedback circuit to produce either a gain curve with a minimum in the middle of the pot rotation, as in FIG. 5, or a maximum gain in the middle of the pot rotation, as in FIG. 6. The gain curve tends to be parabolic. Resistors R1 and R2 add more flexibility by setting gain at the ends of the pot rotation. This partially compensates for variations in the signal amplitude with pot rotation due to phase cancellations in the pickup string signals. But before we can consider how to apply that, we must look at all the possibilities of combining three pickups into two humbucking pairs and then relating them to the output with two orthogonal functions.

Recall from FIG. 4 that the negative hum phases are all grounded, leaving the magnetic pole up to determine the phase of the string signal. Suppose that pickups A, B & C are an N-up neck pickup, N, with string signal N, an S-up middle pickup, M, with string signal −M, and an N-up bridge pickup, B, with string signal B. But we can put any two pickups in place of A and B, and there are three ways to pick humbucking pairs. Namely, (N−B), (N+M) and (M+B). And for two orthogonal functions, Q(x) and R(x), there are three ways to attach a humbucking pair to Q, leaving two ways to attach a humbucking pair to R, for a total of six combinations, as shown in Table 4.

TABLE 4
Ways to attached 3 pickups in humbucking
pairs to 2 orthogonal functions

| | 1^{st} Choice | 2^{nd} Choice |
|---|---|---|
| Choice for Q | for R | for R |
| N − B | M + N | M + B |
| M + B | N − B | M + N |
| M + N | M + B | N − B |

We can see that the first pair is Q(N−B) & R(M+N), and the next to last choice is Q(M+N) & R(N−B), and that they are different because when Q=0, the signal R(M+N) is in the middle of the pot range for the first pair, and R(N−B) is in the middle of the range for the next to last pair. Consider now the switched humbucking pairs and triples in Table 2, using the humbucking pair (N−B) and (M+N). The Humbucking Signal has the form: aN+bM+cB, which we set equal to Q′(N−B)+R′(M+N). We use Q′ and R′ because they are not yet in a form which sits on a unit radius half-circle in (Q,R)-space. Math 10 shows the conversions for Table 2 and the humbucking pair signals (N−B) and (M+N). The calculation of QRrot in Math 10 is equivalent to Math 9.

$$a N + b M + cB = {Q}^{′} ( N - B ) + {R}^{′} ( M + N ) = ( {Q}^{′} + {R}^{′} ) + {Q}^{′} M - {R}^{′} B a = ( {Q}^{′} + {R}^{′} ) , b = {Q}^{′} , c = - {R}^{′} Q = \frac{{Q}^{′}}{\sqrt{{Q}^{′ 2} + {R}^{′ 2}}} , R = \frac{{R}^{′}}{\sqrt{{Q}^{′ 2} + {R}^{′ 2}}} If R < 0 Then : Q ← - Q , R ← - R QRot = 1 - \frac{1}{π} arctan \frac{R}{Q} \\ If Q = 0 Then : QRrot = 0.5 , if QRrot < 0 Then : QRrot ← 1 + QRrot \qquad Math 10$$

Q and R have been defined so that Q can be less than zero as a pseudo-sine function, but as a pseudo-cosine function, R cannot. So if the conversion would produce R<0, then the signs of both Q and R are reversed. Reversing the signs of Q and R merely reflects the output signal Q(N−B)+R(M+N) through the origin from the lower-half plane to the upper-half.

TABLE 5
Results of Math 10 applied to the humbucking pair signal Q(N − B) + R(M + N)
and the results of three P-90 pickups in Table 2.

| HB | | | | | | | | | | Relative |
|---|---|---|---|---|---|---|---|---|---|---|
| Signal | a | b | c | Q′ | R′ | Q | R | QRrot | Fmean | Amplitude |
| N − B | 1 | 0 | −1 | 1 | 0 | 1 | 0 | 1 | 862 | 0.80 |
| B + (M − N)/2 | −½ | ½ | 1 | −1 | ½ | −0.89 | 0.45 | 0.15 | 677 | 1.27 |
| N + (M − B)/2 | 1 | ½ | −½ | ½ | ½ | 0.71 | 0.71 | 0.75 | 645 | 0.91 |
| M + B | 0 | 1 | 1 | −1 | 1 | −0.71 | 0.71 | 0.25 | 589 | 1.56 |
| M + N | 1 | 1 | 0 | 0 | 1 | 0 | 1 | 0.50 | 519 | 1.11 |
| M + (N + B)/2 | ½ | 1 | ½ | −½ | 1 | −0.45 | 0.89 | 0.35 | 509 | 1.49 |

Table 5 shows the results. Note that to save space, Q and R in Table 5 are expressed to only two decimal places. When this is applied to the other 5 humbucking pair combinations in Table 4, Q′ and R′ will be various combinations of 0, ±½, and ±1, which can produce a range of QRrot, as shown in Table 6.

TABLE 6
Range of QRrot for humbucking pair and triple signals. Limited to two
decimal places for space.

| | | | | | | | | | | | |
|---|---|---|---|---|---|---|---|---|---|---|---|
| Q′ | 0.00 | 1.00 | −1.00 | 1.00 | −1.00 | 0.50 | −0.50 | 0.50 | −0.50 | 1.00 | −1.00 |
| R′ | 1.00 | 0.00 | 0.00 | 1.00 | 1.00 | 0.50 | 0.50 | 1.00 | 1.00 | 0.50 | 0.50 |
| Q | 0.00 | 1.00 | −1.00 | 0.71 | −0.71 | 0.71 | −0.71 | 0.45 | −0.45 | 0.89 | −0.89 |
| R | 1.00 | 0.00 | 0.00 | 0.71 | 0.71 | 0.71 | 0.71 | 0.89 | 0.89 | 0.45 | 0.45 |
| Qrrot | 0.50 | 0.00 | 0.00 | 0.25 | 0.75 | 0.25 | 0.75 | 0.35 | 0.65 | 0.15 | 0.85 |

So QRrot can be 0, 0.15, 0.25, 0.35, 0.50, 0.65, 0.75, 0.85 and 1.00 to 2 decimal places. But QRrot is not x, the fractional pot rotation. It is the result of the fractional pot rotation, in the linear gang equations of Maths 7 & 8, applied to either Math 9 or Math 10. The actual amount of pot rotation, x, that produces QRrot has to be calculated, using those equations, generally using a “Solver” or “What If” spreadsheet tool or computer program to find the value of x that fits with the coefficients Q and R derived from humbucking pair and triple signal equations. Table 7 shows the conversion for QRrot to x for Maths 7-10 in FIGS. 5 & 6 with R_{B}=1500 ohms and P=10,000 ohms.

TABLE 7
Conversion from QRrot to x for linear gangs, P = 10 kohms, R_{B} =
1500 ohms, to four decimal places, with the (Q, R) radius, QRrad

| QRrot | x | QRrad |
|---|---|---|
| 0.0000 | 0.0000 | 1.0000 |
| 0.1476 | 0.0605 | 0.9580 |
| 0.2500 | 0.1417 | 0.9773 |
| 0.3524 | 0.2723 | 0.9987 |
| 0.5000 | 0.5000 | 1.0000 |
| 0.6476 | 0.7277 | 0.9987 |
| 0.7500 | 0.8583 | 0.9773 |
| 0.8524 | 0.9395 | 0.9580 |
| 1.0000 | 1.0000 | 1.0000 |

The values for x in Table 7 have to be used in the rotation of the pot gang, Pgc, in the gain circuit about U3 in FIGS. 5 & 6. Table 8 shows Table 5 with the Q′ and R′ columns deleted and the x column added, using the conversion in Table 7. Here Table 8 is re-ordered to increasing values of x in the rows, and the last row for x=1 and the humbucking signal −(N−B) is added, representing the other end of the pot rotation. This is the only duplicate tonal signal over the entire range of the pot rotation.

TABLE 8
Table 5 recast with x added, for aN + bM + cB → Q(N − B) + R(M + N),
P = 10kΩ, R_{B} = 1500Ω, in FIGs. 5 & 6, for three P-90 pickups from Table 2 data

| | | | | | | | | Mean | Relative |
|---|---|---|---|---|---|---|---|---|---|
| HB | | | | | | | | Freq | Amplitude |
| Signal | a | b | c | Q | R | QRrot | x | (Hz) | V_{HB} |
| N − B | 1 | 0 | −1 | 1.00 | 0.00 | 1.00 | 1.00 | 862 | 0.8 |
| N + (M − B)/2 | 1 | ½ | −½ | 0.71 | 0.71 | 0.75 | 0.86 | 645 | 0.91 |
| M + N | 1 | 1 | 0 | 0.00 | 1.00 | 0.50 | 0.50 | 519 | 1.11 |
| M + (N + B)/2 | ½ | 1 | ½ | −0.45 | 0.89 | 0.35 | 0.27 | 509 | 1.49 |
| M + B | 0 | 1 | 1 | −0.71 | 0.71 | 0.25 | 0.14 | 589 | 1.56 |
| B + (M − N)/2 | −½ | ½ | 1 | −0.89 | 0.45 | 0.15 | 0.06 | 677 | 1.27 |
| −(N − B) | −1 | 0 | 1 | −1.00 | 0.00 | 0.00 | 0.00 | 862 | 0.8 |

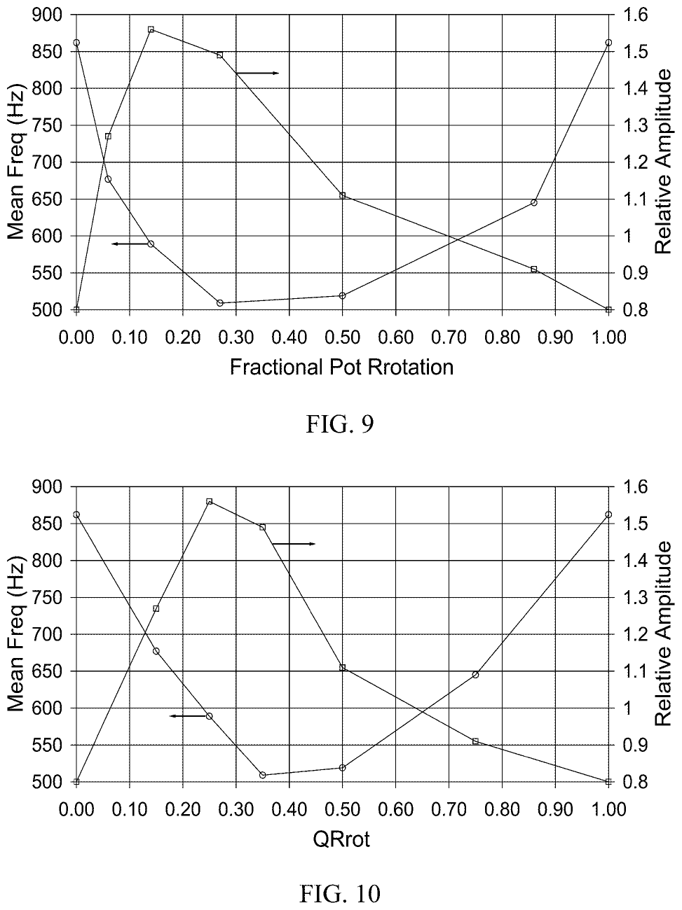

FIG. 9 shows the plot of mean frequency versus x, against the left-hand vertical axis and the Relative Amplitude, Rel-Amp versus x, against the right-hand vertical axis. FIG. 10 plots the same variable against QRrot, to show what the curves would look like if there were no rotation distortion between QRrot and x. The lines with box points are mean frequency in Hz plotted against the left-hand axis; the lines with circle points are relative amplitude plotted against the right-hand axis. Notice how the distortion affects the shape of the curves. It would not be present in FIG. 9 if Q were a true sine function and R were a true cosine function. Note that the higher mean frequencies, 645, 677 and 862 Hz all have minus signs in the Humbucking Signal column of Table 8.

### Fitting the 3^{rd} Linear Pot Gang Circuit to Compensate for Relative Amplitude

The right-hand circuit using U3 in FIGS. 5 & 6 is intended as both a summer for Q(A−B) and R(B−C) and to compensate, if possible, for differences in relative amplitude due to signal phase cancellations, as in FIG. 9. Note that the ratio of highest to lowest amplitude signal from Table 2 is 1.56 to 0.80, or about 1.95 to 1. In the case of the composite humbucking signal, V_{HB}=Q(N−B)+R(M+N), as shown in FIG. 9, the outputs with relative amplitudes of 0.80 sit at the ends of the pot rotation, and the relative amplitude of 1.56 sits at x=0.85. So we choose FIG. 5, because the minimum gain for the summation and gain circuit formed by R_{S}, R_{S}, R_{F}, Pgc, R₁, R₂ and U3, will have a minimum gain at the center of the pot rotation. Note also the difference between the summer circuits in FIG. 1, where summer input is on the negative input of U3, and FIG. 5, where the summer input is on the plus input of U3. This means that the resistors R_{S} & R_{S} in FIG. 5 form a voltage divider, that cuts the composite signal in half, and must be made up in the feedback gain. Math 11 shows the derivation of the gain.

$$e 1 : {V}_{2} = \frac{{V}_{HB}}{2} = \frac{( {V}_{Q} + {V}_{R} )}{2} e 2 : {V}_{3} \to {V}_{2} e 3 : \frac{{V}_{3} - V o}{{R}_{F}} + \frac{{V}_{3}}{{R}_{1} + x P} + \frac{{V}_{3}}{{R}_{2} + ( 1 - x ) P} = 0 Solution : \frac{V o}{{V}_{H B}} = \frac{\begin{matrix}x ( 1 - x ) {P}^{2} + ( ( 1 - x ) {R}_{1} + x {R}_{2} + {R}_{F} ) P + \\ {R}_{1} {R}_{2} + ( {R}_{1} + {R}_{2} ) {R}_{F}\end{matrix}}{2 ( {R}_{1} + x P ) ( {R}_{2} + ( 1 - x ) P )} \qquad Math 11$$

The gain of Vo/V₂ must always be greater than 1 for the circuit to work, and has to be at least 2 to bring back V_{HB} in full force. We can accomplish this by setting a desired target output of Vo=2>V_{HB}=1.56, and solving for the best fit by changing R_{F}, R₁ and R₂, using the seven data (x, V_{HB}) points in Table 8, where V_{HB} is taken to be the Relative Amplitude. In this case, we take an objective function of the sum of squares of the percentage variation of Vo from 2, or SUMSQ((Voi−2)/2), and change R_{F}, R₁ and R₂ to obtain a minimum. Using any other optimizing measure is left as an exercise for the reader. Results will vary with the objective function. We will find that, because the curves in FIG. 9 are skewed so far to the right of center, the summing and adjustment circuit in FIG. 5 will not be a very good fit with a linear pot. All six sets of humbucking pair functions from Table 4 will have to be tried. Some of the humbucking pairs will require the summer circuit in FIG. 6. Math 12 shows the solution for that.

$$e 1 : {V}_{2} = \frac{{V}_{HB}}{2} = \frac{( {V}_{Q} + {V}_{R} )}{2} e 2 : {V}_{3} \to {V}_{2} e3 : \frac{{V}_{3}}{{R}_{F}} + \frac{{V}_{3} - V o}{{R}_{1} + x P} + \frac{{V}_{3} - V o}{{R}_{2} + ( 1 - x ) P} = 0 Solution : \frac{Vo}{{V}_{HB}} = \frac{\begin{matrix}x ( 1 - x ) {P}^{2} + ( ( 1 - x ) {R}_{1} + x {R}_{2} + {R}_{F} ) P + \\ {R}_{1} {R}_{2} + ( {R}_{1} + {R}_{2} ) {R}_{F}\end{matrix}}{2 {R}_{F} ( {R}_{1} + {R}_{2} + P )} \qquad Math 12$$

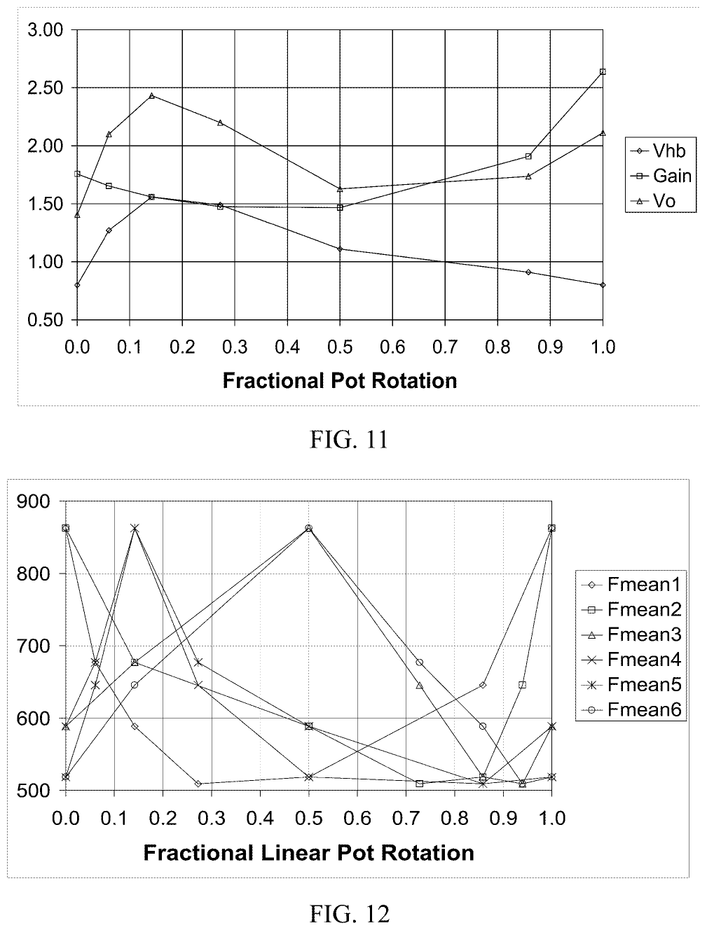

In this example, the QRrad numbers from Table 7 have been neglected. The values of Relative Amplitude from Table 2 are used directly instead of being corrected by multiplication by the values of QRrad. FIG. 11 shows the graphical optimization results for the U3 summer-gain-compensation circuit in FIG. 5 with V_{HB}=Q(N−B)+R(M+N) and P=10 kΩ,R_{F}=7694Ω, R₁=4096Ω and R₂=2059Ω, where V_{HB} is the line with diamond points, listed as Vhb in the legend, the Gain, Vo/V_{HB}, is the line with square points, and the output, Vo, is the line with triangle points. Table 9 shows the numerical results. Note that the ends of the pot, with a mean frequency of 862 Hz, must be shown, because the gain of the summer circuit is not the same at the ends with R₁ and R₂ different.

TABLE 9
Results for fitting R₁, R₂ and R_{F} in the U3 summer circuit in FIG. 5 for
V_{HB} = Q(N − B) + R(M + N), with a target value of Vo = 2, using an objective function of
SUMSQ((Voi − 2)/2), with P = 10kΩ, R_{F} = 7694Ω, R₁ = 4096Ω and R₂ = 2059Ω

| | | | V_{HB} Variation | | | Vo Variation | | Variation |
|---|---|---|---|---|---|---|---|---|
| x | Fmean | V_{HB} | From Mean | Gain | Vo | From Mean | Vo-2 | From 2 |
| 0.0000 | 862 | 0.80 | −0.295 | 2.638 | 2.111 | 0.085 | 0.111 | 0.055 |
| 0.1476 | 645 | 0.91 | −0.198 | 1.909 | 1.737 | −0.107 | −0.263 | −0.131 |
| 0.5000 | 519 | 1.11 | −0.021 | 1.467 | 1.629 | −0.162 | −0.371 | −0.186 |
| 0.7277 | 509 | 1.49 | 0.314 | 1.476 | 2.199 | 0.131 | 0.199 | 0.099 |
| 0.8583 | 589 | 1.56 | 0.375 | 1.559 | 2.432 | 0.250 | 0.432 | 0.216 |
| 0.9395 | 677 | 1.27 | 0.120 | 1.654 | 2.100 | 0.080 | 0.100 | 0.050 |
| 1.0000 | 862 | 0.80 | −0.295 | 1.758 | 1.406 | −0.277 | −0.594 | −0.297 |
| | Mean = | 1.13 | 0 | 1.78 | 1.94 | 0.00 | −0.06 | −0.03 |
| | SumSq = | | 0.466788064 | | | 0.2079514 | 0.80785 | 0.201963 |

Note that the Gain is roughly parabolic in FIG. 11, where the minimum does not match well with the peak in V_{HB} at x=0.86. The second part of the invention, a pot with a nonlinear taper, will address this better. Although the vertical span of Vo looks much greater than the vertical span of V_{HB}, the percent variation from the mean of V_{HB}, 1.13, and between Vo and 2 tell a different story. The fractional deviation of V_{HB} from its mean, 1.13, (V_{HB}−1.13)/1.13), varies from −0.295 to +0.375 with a sum-squared value of 0.467. The fractional deviation of Vo from its target, 2.00, (Vo−2)/2, varies from −0.297 to 0.216, with a sum-squared value of 0.204. The total deviation of Vo from 2 is better than the total deviation of V from its mean is better by a factor of 1 to 1.306. Only slightly better, but still better. But there are still five more humbucking pair functional combinations to try.

Choosing different combinations of humbucking pairs in Table 4 to use with Q and R to create a composite tone mainly changes the order of occurrence of the switched tones from Table 2 as the pot in FIGS. 5 & 6 is turned to generate Q and R. Or, it changes to position of the point on the x-axis. We shall see that for a given humbucking pair attached to Q, changing the pair attached to R changes the distribution of the points on the x-axis. But for a given humbucking pair attached to R, changing the pair attached to Q changes the order of the points on the x-axis. At least in this case. Working one's way through the changes systematically, Table 9 shows how the coefficients, a, b & c of the switched tones convert to Q′ and R′ (Math 10) of the humbucking pairs.

TABLE 9
Conversion of coefficients of aN + bM + cB
to humbucking pairs using Q′ and R′

| | a | b | c |
|---|---|---|---|
| Q′(N − B) + R′(M + N) | Q′ + R′ | R′ | −Q′ |
| Q′(N − B) + R′(M + B) | Q′ | R′ | R′ − Q′ |
| Q′(M + B) + R′(N − B) | R′ | Q′ | Q′ − R′ |
| Q′(M + B) + R′(M + N) | R′ | Q′ + R′ | Q′ |
| Q′(M + N) + R′(M + B) | Q′ | Q′ + R′ | R′ |
| Q′(M + N) + R′(N − B) | Q′ + R′ | Q | −R′ |

Tables 10-15 show the results of computing Q and R from the humbucking circuit signals in Table 2, expressed as aN+bM+cB, using Table 9 and Math 10, for the QR forms: Q(N−B)+R(M+N), Q(N−B)+R(M+B), Q(M+B)+R(N−B), Q(M+B)+R(M+N), Q(M+N)+R(M+B) and Q(M+N)+R(N−B). The minus signs in the first column, HB Circuit, indicate that the original value of R was negative and that the signs of both Q and R were changed to put the (Q,R) point in the upper-half plane. The results have been sorted so that the QRrot and x columns always increase going down. These results show how the mean frequency, Fmean, and relative amplitude, RelAmp, values from associated with the humbucking circuits in Table 2 distribute along the fractional linear pot rotation, x, because of the associations of humbucking pairs with Q an R in Tables 4 & 9.

TABLE 10
QRrot and x Results for Q(N − B) + R(M + N)

| HB Circuit | QRrot | x | Fmean | RelAmp |
|---|---|---|---|---|
| −(N − B) | 0.000 | 0.000 | 862.3 | 0.8 |
| B + (M − N)/2 | 0.148 | 0.061 | 677.1 | 1.27 |
| M + B | 0.250 | 0.142 | 588.6 | 1.56 |
| M + (N + B)/2 | 0.352 | 0.272 | 509 | 1.49 |
| M + N | 0.500 | 0.500 | 518.7 | 1.11 |
| N + (M − B)/2 | 0.750 | 0.858 | 645.4 | 0.91 |
| N − B | 1.000 | 1.000 | 862.3 | 0.8 |

TABLE 11
QRrot and x Results for Q(N − B) + R(M + B)

| HB Circuit | QRrot | x | Fmean | RelAmp |
|---|---|---|---|---|
| −(N − B) | 0.000 | 0.000 | 862.3 | 0.8 |
| B + (M − N)/2 | 0.250 | 0.142 | 677.1 | 1.27 |
| M + B | 0.500 | 0.500 | 588.6 | 1.56 |
| M + (N + B)/2 | 0.648 | 0.728 | 509 | 1.49 |
| M + N | 0.750 | 0.858 | 518.7 | 1.11 |
| N + (M − B)/2 | 0.852 | 0.940 | 645.4 | 0.91 |
| N − B | 1.000 | 1.000 | 862.3 | 0.8 |

TABLE 12
QRrot and x Results for Q(M + B) + R(N − B)

| HB Circuit | QRrot | x | Fmean | RelAmp |
|---|---|---|---|---|
| −(M + B) | 0.000 | 0.000 | 588.6 | 1.56 |
| −(B + (M − N)/2) | 0.250 | 0.142 | 677.1 | 1.27 |
| N − B | 0.500 | 0.500 | 862.3 | 0.8 |
| N + (M − B)/2 | 0.648 | 0.728 | 645.4 | 0.91 |
| M + N | 0.750 | 0.858 | 518.7 | 1.11 |
| M + (N + B)/2 | 0.852 | 0.940 | 509 | 1.49 |
| M + B | 1.000 | 1.000 | 588.6 | 1.56 |

TABLE 13
QRrot and x Results for Q(M + B) + R(M + N)

| HB Circuit | QRrot | x | Fmean | RelAmp |
|---|---|---|---|---|
| −(M + B) | 0.000 | 0.000 | 588.6 | 1.56 |
| −(B + (M − N)/2) | 0.148 | 0.061 | 677.1 | 1.27 |
| N − B | 0.250 | 0.142 | 862.3 | 0.8 |
| N + (M − B)/2 | 0.352 | 0.272 | 645.4 | 0.91 |
| M + N | 0.500 | 0.500 | 518.7 | 1.11 |
| M + (N + B)/2 | 0.750 | 0.858 | 509 | 1.49 |
| −(M + B) | 1.000 | 1.000 | 588.6 | 1.56 |

TABLE 14
QRrot and x Results for Q(M + N) + R(M + B)

| HB Circuit | QRrot | x | Fmean | RelAmp |
|---|---|---|---|---|
| −(M + N) | 0.000 | 0.000 | 518.7 | 1.11 |
| −(N + (M − B)/2) | 0.148 | 0.061 | 645.4 | 0.91 |
| −(N − B) | 0.250 | 0.142 | 862.3 | 0.8 |
| B + (M − N)/2 | 0.352 | 0.272 | 677.1 | 1.27 |
| M + B | 0.500 | 0.500 | 588.6 | 1.56 |
| M + (N + B)/2 | 0.750 | 0.858 | 509 | 1.49 |
| M + N | 1.000 | 1.000 | 518.7 | 1.11 |

TABLE 15
QRrot and x Results for Q(M + N) + R(N − B)

| HB Circuit | QRrot | x | Fmean | RelAmp |
|---|---|---|---|---|
| −(M + N) | 0.000 | 0.000 | 518.7 | 1.11 |
| −(N + (M − B)/2) | 0.250 | 0.142 | 645.4 | 0.91 |
| −(N − B) | 0.500 | 0.500 | 862.3 | 0.8 |
| B + (M − N)/2 | 0.648 | 0.728 | 677.1 | 1.27 |
| M + B | 0.750 | 0.858 | 588.6 | 1.56 |
| M + (N + B)/2 | 0.852 | 0.940 | 509 | 1.49 |
| M + N | 1.000 | 1.000 | 518.7 | 1.11 |

TABLE 16
QRrot and x Results for Q(x), R(x) &
humbucking pairs in FIGS. 12 & 13

| | |
|---|---|
| Q(N − B) + R(M + N) | Fmean1, Relamp1 |
| Q(N − B) + R(M + B) | Fmean2, Relamp2 |
| Q(M + B) + R(N − B) | Fmean3, Relamp3 |
| Q(M + B) + R(M + N) | Fmean4, Relamp4 |
| Q(M + N) + R(M + B) | Fmean5, Relamp5 |
| Q(M + N) + R(N − B) | Fmean6, Relamp6 |

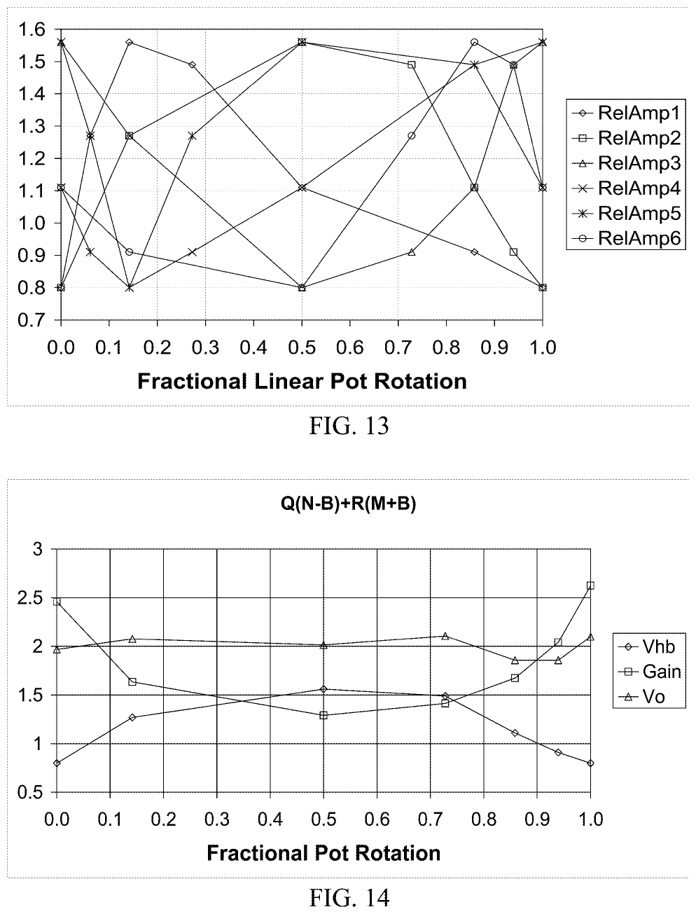

Table 16 gives the associations of QR-forms to variables in FIGS. 12 & 13. FIG. 12 shows the plot of mean frequencies, Fmean, for all six choices of Q, R and humbucking pairs. Note how sets of two curves meet at the middle where Q=0 and sets of two meet at ends where R=0. Note how the curves for Fmean4 & Fmean5 have peaks for Fmean=862 Hz which are not at either the middle or the ends. FIG. 13 shows similar curves for the relative amplitude, RelAmp. These curves are more important than those in FIG. 12, because we will use them to optimize the U3 summer to compensate for differences in RelAmp. Note how the curve for RelAmp1 from Table 10, already plotted in FIG. 11, peaks way to the left of center, at x=0.858, and falls off monotonically to the sides. RelAmp2 has a peak at x=0.5 and falls off monotonically on both sides. RelAmp3 has a minimum at x=0.5, and rises monotonically on both sides. RelAmp4 from Table 13 has a minimum at x=0.142 and rises monotonically on both sides. It will not be easy to fit. RelAmp5 from Table 14 has a maximum at x=0.5 and minimum a at x=0.142, and will be hard to fit. RelAmp6 from Table 15 has a maximum at x=0.858 and a minimum at x=0.5, and will also be hard to fit.

This illustrates the value of actually plotting the results of using pickups on a guitar before designing circuits, and having at least a rough estimate of how those pickups with work with those circuits.

TABLE 17
Results of minimizing the Objective Function =
SUMSQ((Vo(xᵢ) − 2)/2) by varying R₁, R₂ & R_{F}
in FIGS. 5 & 6, using data from Tables 10-15

| Table & HB Relation | Fit Math 11 to FIG. 5 | Fit Math 12 to FIG. 6 |
|---|---|---|
| Table 10: | 0.2022 | 0.4441 |
| Q(N − B) + R(M + N) | | |
| Table 11: | 0.0173 | 0.4376 |
| Q(N − B) + R(M + B) | | |
| Table 12: | 0.3607 | 0.0350 |
| Q(M + B) + R(N − B) | | |
| Table 13: | 0.3608 | 0.1661 |
| Q(M + B) + R(M + N) | | |
| Table 14: | 0.1781 | 0.2490 |
| Q(M + N) + R(M + B) | | |
| Table 15: | 0.2201 | 0.1977 |
| Q(M + N) + R(N − B) | | |

Table 17 shows the results of fitting FIGS. 5 & 6 to the data in Tables 10-15, in minimizing the sum-squared error of ((Vo(xᵢ)−2)/2) by varying R₁, R₂ & R_{F} in Math 11 and Math 12, respectively. FIG. 14 shows plots similar to FIG. 11, for the data from Table 11, fitted in FIG. 5 by Math 11, with Rf=5052 ohms, R1=1327 ohms and R2=1454 ohms, with the smallest objective function value, 0.0173. The mean value of V_{HB}, or RelAmp, in Table 11 is 1.13. The sum-squares (V_{HB}(xᵢ)−1.13)/1.13 is 0.4668. So the improvement using gain compensation is 27.0 to 1. In this case the deviation of V_{HB} from 2 is −0.144 to 0.105.

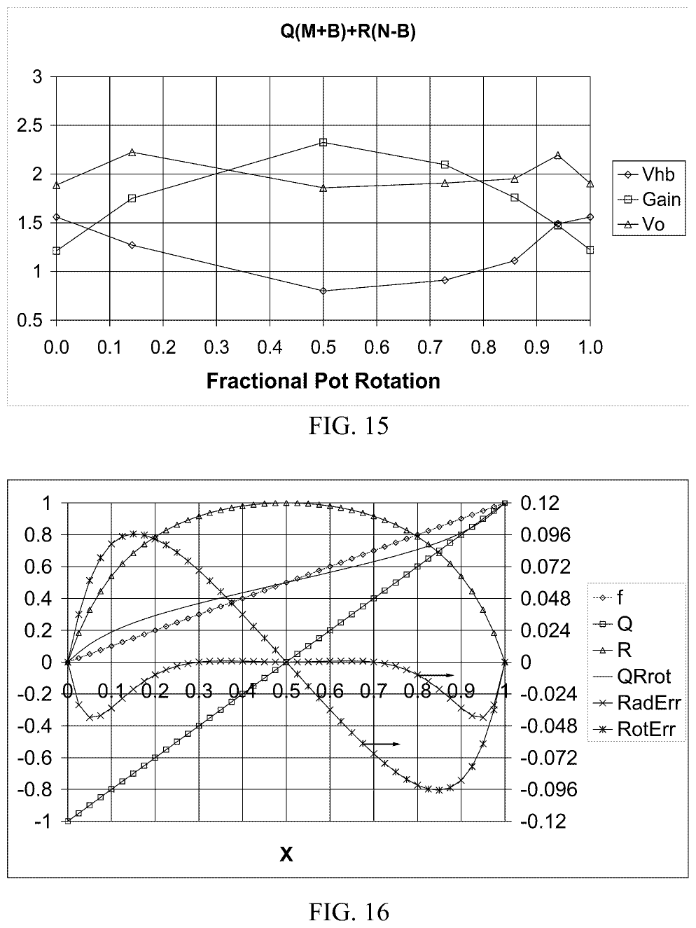

FIG. 15 shows the plot for the data in Table 12, fitted in FIG. 6 by Math 12, with Rf=879 ohms, R1=1425 ohms and R2=1400 ohms, with the second smallest objective function value, 0.0350. Since the value at the ends of the plot for V_{HB} are 1.56 instead of 0.80, the mean value of V_{HB} in this case is 1.24. The sum-squares (V_{HB}(xᵢ)−1.13)/1.13 is 0.3804. So the improvement using gain compensation is 10.9 to 1. In this case the deviation of V_{HB} from 2 is −0.140 to 0.224.

So for at least two different approaches, using either Q(N−B)+R(M+B) or Q(M+B)+R(N−B), gain compensation in the summer stage, U3+components, works to overcome output variations due to string signal phase cancellations. The Q(N−B)+R(M+B) setup has the smallest error and puts the brightest tone at both ends of the pot rotation. The Q(M+B)+R(N−B) setup has the next smallest error and improvement, and puts the brightest tone at the middle of the pot rotation.

For 4 or more pickups, original combinations of humbucking pairs using the circuit in FIG. 5 or 6, can be cascaded with the same circuit, similar to FIG. 4, to linearly combine all the humbucking pairs into one output. But the considerations for optimizing the U3-type gains in the downstream circuits become more complicated above three matched pickups. Work remains to be done in this area. Nevertheless, the invention as it stands is a good drop-in pickguard upgrade for the millions of existing 3-coil electric guitars.

### A Nonlinear 3-Gang Pot with One Common Taper

The consequences of the nonlinearities of angular rotation, QRrot, in the circuits in the pseudo-sine and pseudo-cosine circuit produced by pot gangs Pga and Pgb in FIGS. 5 & 6 can be adjusted by making the same slight changes to the taper of all three pot gangs. Potentiometer manufacturer custom tapers, sometimes called B or W or M or S tapers, depending on the maker, indicate that the necessary changes are well within the capabilities of manufacturing process. All that is necessary is a piecewise polynomial function, f(x), where x is the fractional pot rotation, and f(x) is the resistance between the pot wiper and the x=0 end. The curve is symmetrical and slightly S-shaped, and defined by the conditions in Math 13.

$$f ( x ) = \{ \begin{matrix}{f}_{1} ( x ) , 0 \leq x \leq 0.5 \\ {f}_{2} ( x ) , 0.5 \leq x \leq 1\end{matrix} , with conditions : {f}_{1} ( 0 ) = 0 , {f}_{1} ( 0.5 ) = 0 \text{.5} , {f}_{2} ( 0.5 ) = 0 \text{.5} , {f}_{2} ( 1 ) = 10 \leq {f}_{1}^{′} ( 0 ) = {f}_{2}^{′} ( 1 ) < 1 , {f}_{1}^{′} ( 0.5 ) = {f}_{2}^{′} ( 0.5 ) > 1 {f}_{1} ( x ) is of the form : {f}_{1} ( x ) = {\sum }_{i = 1}^{k} {a}_{i} {x}^{i} , {f}_{1} ( 0 ) = 0 ⇒ {a}_{0} = 0 {f}_{2} ( x ) is of the form : {f}_{2} ( x ) = {\sum }_{i = 0}^{k} {b}_{i} {x}^{i} \qquad Math 13$$

All of the pot taper functions presented here are of the form in Math 13, except for some variations in conditions on the first derivative with respect to x. Even the linear taper fits the general definition. And all have a form of symmetry. Start with f(0)=0, f(0.5)=0.5 and f(1)=1. For a variable, u, such that 0≤u≤0.5, the line passing from (0.5−u,f(0.5−u) to (0.5+u,f(0.5+u) will always pass through (0.5,f(0.5))=(0.5,0.5). For clarity, the Claims will assign the taper function f(x) to Pga, g(x) to Pgb and h(x) to Pgc. But they are all of this general quality, of which Math 13 is a subset. Sometimes will be all the same function, as in the previous sections, where they were all f(x)=g(x)=h(x)=x, the linear taper.

For k=1 in Math 13, f₁(x)=f₂(x)=x, the linear pot already addressed, which means that Q(x)=2f(x)−1=2x−1. We will try k=2, 3 & 4, as shown in Maths 14-17. The first condition in Math 13, f₁(0)=0, means that a₀=0. That leaves 5 other conditions which can be used to reduce the number of unknown coefficients, aᵢ and bᵢ, to terms involving just a few unknown coefficients, to be used as one or more parameters with R_{B}, in the method using Maths 7, 8 & 9 to get from Table 2 to Table 3. In Math 14, one can use all five remaining conditions, in which a symbolic math solution package leaves b₀ as the controlling parameter, or use only four of the remaining conditions, as was done here, and solve for a₁ as the controlling parameter.

For k=2:f₁(x)=a₁x+a₂x², f₂(x)=b₀+b₁x+b₂x²

Using a₁ as parameter, solves to:

f₁(x)=a₁x+2(1−a₁)x²

f₂(x)=a₁−1+(4−3a₁)x+2(a₁−1)x² Math 14.

Provided: 0≤a₁<1

For k=3:f₁(x)=a₁x+a₂x²+a₃x³, f₂(x)=b₀+b₁x+b₂x²+b₃x³

Using a₁ & b₀ as parameters, solves to:

f₁(x)=a₁x+(3−3a₁+b₀)x² +(2a₁−2b₀ −2)x³

f₂(x)=b₀+(a₁−4b₀)x+(5b₀−3a₁+3)x²+(2a₁−2b₀−2)x³ Math 15.

Provided: 0≤a₁<1, b₀<1−a₁

For k=4:

f₁(x)=a₁x+a₂x²+a₃x³+a₄x⁴,

f₂(x)=b₀+b₁x+b₂x²+b₃x³+b₄x⁴,

Using a₁, a₂, b₀& b₁ as parameters, solves to:

f₁(x)=a₁x+a₂x²+(6b₀+b₁−11a₁−4a₂+10)x³+(14a₁+4a₂−12b₀−2b₁−12)x⁴

f₂(x)=b₀+b₁x+(a₁+3−11b₀−4b₁)x²+(18b₀+5b₁−3a₁−2)x^{3 +(}2a₁−8b₀−2b₁)x⁴ Math 16.

Provided: 0≤a₁<1, 6b₀+b₁<2−a₁

For k=4, a,₃=b₃=0:

f₁(x)=a₁x+a₂x²+a₄x⁴,

f₂(x)=b₀+b₁x+b₂x²+b₄x⁴

Using a₁ & b₀ as parameters, solves to:

$${f}_{1} ( x ) = {a}_{1} x + ( \frac{3}{5} {b}_{0} - \frac{13}{5} {a}_{1} + \frac{13}{5} ) {x}^{2} + ( \frac{12}{5} {a}_{1} - \frac{12}{5} {b}_{0} - \frac{12}{5} ) {x}^{4} {f}_{2} ( x ) = {b}_{0} + ( \frac{3}{5} {a}_{1} - \frac{18}{5} {b}_{0} + \frac{2}{5} ) x + ( \frac{17}{5} {b}_{0} - \frac{7}{5} {a}_{1} + \frac{7}{5} ) {x}^{2} + ( \frac{4}{5} {a}_{1} - \frac{4}{5} {b}_{0} - \frac{4}{5} ) {x}^{4} \qquad Math 17$$

$$Provided : 0 \leq {a}_{1} < 1 , 3 {b}_{0} < 2 ( 1 - {a}_{1} )$$

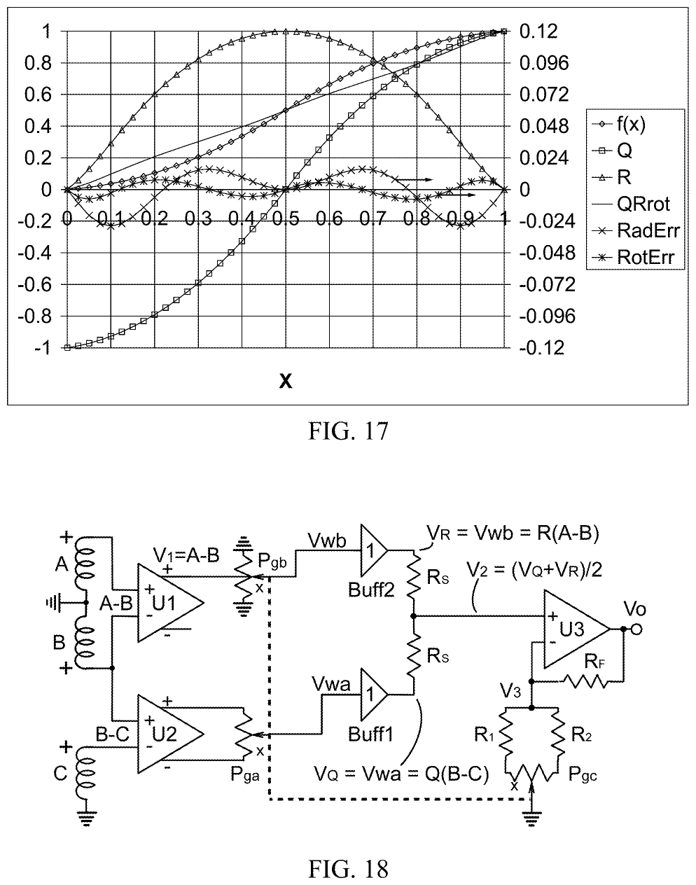

In each of Maths 14-17, the resulting equations for f₁(x) and f₂(x) are verified to meet the conditions. Substituting f(x) for x in Maths 7&8 for the linear pot gangs produces Q(x) and R(x) for the nonlinear pot gangs. A spreadsheet was calculated and tabulated for each of the equations in Math 7&8, and Maths 14-17. The pot value was set to P=1, and R_{B} and the indicated parameters in Maths 14-17 were set up accordingly. The first column calculated x from 0 to 1 in 40 steps of 0.025. The next columns, respectively, calculated f(x), Q(x), R(x), RadErr, QRrot and RotErr, where RadErr is the radius error, SQRT(Q²+R²)−1, QRrot is the QR-plane rotation of (Q,R), as calculated as in Math 9, and RotErr is QRrot(x)−x. The maximum, minimum and sum-squared values of RadErr and RotErr were calculated. The objective function to be minimized by the parameters is ObjFunct=SUMSQ(RadErrᵢ)+MAX(RotErrᵢ)+ABS(MIN(RotErrᵢ), i=0, 40. Table 18 below shows these results. The numbers in bold print are the variable parameters. FIG. 16 shows the results for the linear pot gangs, Pga & Pgb, as determined by Maths 7&8. FIG. 17 shows the results for the nonlinear pot gangs, as determined by Math 14.

TABLE 18
Fitting solutions for RB and f(x) for Maths 7, 8 & 14-17. Variable parameters
designated by bold letters; empty parameters not used. RadErr is radius error,
SQRT(Q² + R²) − 1, RotErr is rotational error, the difference between
the normalized clockwise rotation of (Q, R) from (−1, 0) and the
normalized clockwise rotation of the pot. The pot value is normalized
to P = 1. ObjFunct = SUMSQ(RadErrᵢ) + MAX(RotErrᵢ) +
ABS(MIN(RotErrᵢ), i = 0, 40.

| | Maths 7&8 | Math 14 | Math 15 | Math 16 | Math 17 |
|---|---|---|---|---|---|
| RB | 0.22909 | 0.16339 | 0.16651 | 0.16248 | 0.16357 |
| a1 | 1.00000 | 0.20573 | 0.22194 | 0.28030 | 0.21556 |
| a2 | | 1.58855 | 1.46407 | 0.74723 | 1.52184 |
| a3 | | | 0.18409 | 2.58493 | |
| a4 | | | | −2.40118 | 0.18818 |
| b0 | | −0.79427 | −0.87010 | −0.23052 | −0.86285 |
| b1 | | 3.38282 | 3.70236 | 0.04027 | 3.63560 |
| b2 | | −1.58855 | −2.01634 | 5.65493 | −1.83547 |
| b3 | | | 0.18409 | −6.78890 | |
| b4 | | | | 2.32422 | 0.06273 |
| Max(RadErr) | 0.00086 | 0.01553 | 0.01440 | 0.01588 | 0.01548 |
| Min(RadErr) | −0.04171 | −0.02784 | −0.02855 | −0.02758 | −0.02788 |
| SumSq(RadErr) | 0.01423 | 0.00885 | 0.00903 | 0.00909 | 0.00892 |
| Max(RotErr) | 0.09660 | 0.00734 | 0.00633 | 0.00550 | 0.00682 |
| Min(RotErr) | −0.09660 | −0.00734 | −0.00633 | −0.00558 | −0.00648 |
| SumSq(RotErr) | 0.18311 | 0.00092 | 0.00082 | 0.00051 | 0.00087 |
| ObjFunct | 0.20743 | 0.02354 | 0.02169 | 0.02016 | 0.02222 |

The Figures and Table make it clear that there is a huge improvement, mostly in the rotational error, going from Maths 7&8 to Math 14, with a reduction in the Objective Function of 8.8 times. But the improvements going from Math 14 to Maths 15-17 are relatively variable and minor. Therefore, it is reasonable to be satisfied with corrections in Math 14. When the standard potentiometer accuracy tolerance in electric guitar pots is ±10% or ±20%, it may be asking a bit much to distinguish between Math 14 and Math 16.

### A Nonlinear 3-Gang Pot with Two Different Gang Tapers & Center-Tapped Pgb

If the pot gangs Pga and Pgb don't have to have the same taper functions, another possibility arises. FIG. 18 shows FIG. 5 with an alternate circuit about pot gang Pgb. Here R_{B} has been removed, the buffer, Buff2, has a gain of 1, and pot gang Pgb now has a center-tap input with both ends of the wiper rotation grounded. For x=0 and x=1, the pot output voltage Vwb=0. For x=½, Vwb=(A−B). A pot with a center-tap will likely be more expensive than the replaced resistor, R_{B}, but the gain of Buff2, in FIG. 5 need no longer be calibrated to the manufacturing tolerances of R_{B} and P.

We can start to understand pot gang Pgb in FIG. 18 by scaling the pot total resistance to 1 and assuming that it has a linear taper, with g(x)=x. Then the pot resistance from the center tap at x=½ to ground at x=0 or x=1 is ½. When 0≤x≤0.5, the resistance from the wiper to the ground at x=0 is x, and Vwb/V₁=x/(½)=2x. When 0.5≤x≤1, the resistance from the wiper to ground at x=1 is 1−x, and Vwb/V₁=(1−x)/(½)=2(1−x). With this linear taper, the plot of Vwb(x)/V₁ is a triangle, and not very useful in this application. Let Math 14 still hold for pot gang Pga and Q(x), where Q(x)=2(f(x)−½) and 0≤f(x)≤1. Let pot gang Pgb use Math 18, with the output, Vwb/V₁=R(x), as shown in Math 19. Math 18 has the same form as Math 14, but the coefficients, cᵢ and dᵢ are different for different pot taper curve.

$$For k = 2 : {g}_{1} ( x ) = {c}_{1} x + {c}_{2} {x}^{2} , {g}_{2} ( x ) = {d}_{0} + {d}_{1} x + {d}_{2} {x}^{2} g ( x ) = \{ \begin{matrix}{g}_{1} ( x ) , 0 \leq x \leq 0.5 \\ {g}_{2} ( x ) , 0.5 < x \leq 1\end{matrix} Using {c}_{1} as parameter , solves to : {g}_{1} ( x ) = {c}_{1} x + 2 ( 1 - {c}_{1} ) {x}^{2} {g}_{2} ( x ) = {c}_{1} - 1 + ( 4 - 3 {c}_{1} ) x + 2 ( {c}_{1} - 1 ) {x}^{2} Provided : 0 \leq {a}_{1} < 2 \qquad Math 18$$

$$\frac{V w b}{{V}_{1}} = R ( x ) = \{ \begin{matrix}2 ⋆ {g}_{1} ( x ) , 0 \leq x \leq 0.5 \\ 2 ⋆ ( 1 - {g}_{2} ( x ) ) , 0.5 < x \leq 1\end{matrix} \qquad Math 19$$

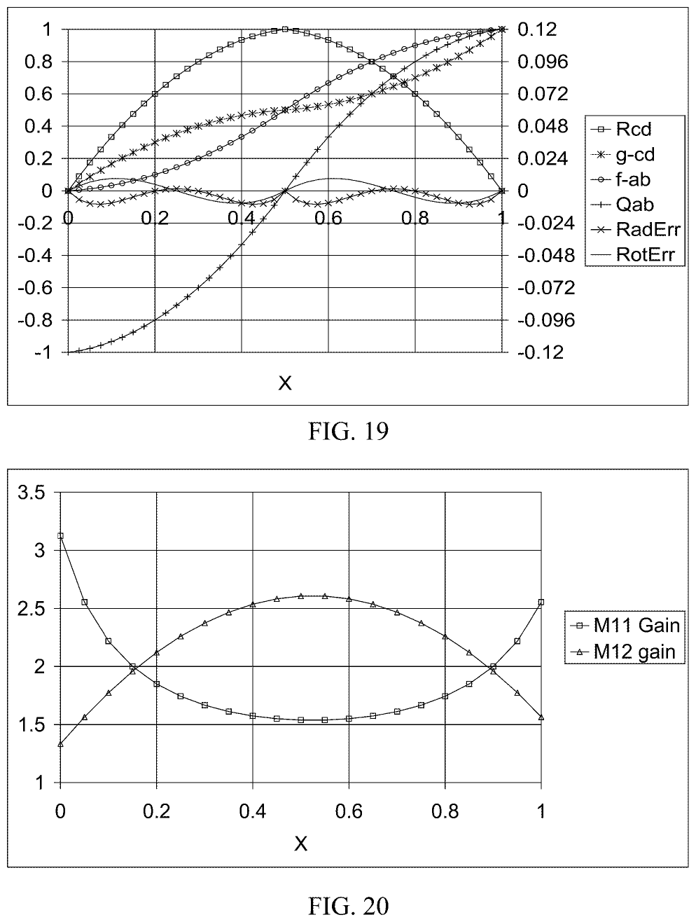

FIG. 19 shows the graphic results, for x₁=0 to 1 in steps of 0.025, i=1,40, where Rcd is as described in Math 19, g-cd is described as g(x) in Math 18, f-ab is described as f(x) in Maths 13 & 14, Qab=Q(x)=2*(f(x)−½), RadErr is the radius error, (SQRT(Q(x)²+R(x)²)−1), and RotErr is the rotation error, (QRrot−1), where QRrot is as defined in Math 9.

TABLE 19
Q(x) coefficients in f(x) and R(x) coefficients in g(x)

| | |
|---|---|
| f(x) coefficients | g(x) coefficients |

| | | | |
|---|---|---|---|
| a1 = | 0.16709 | c1 = | 1.83291 |
| a2 = | 1.66581 | c2 = | −1.66581 |
| b0 = | −0.83291 | d0 = | 0.83291 |
| b1 = | 3.49872 | d1 = | −1.49872 |
| b2 = | −1.66581 | d2 = | 1.66581 |

TABLE 20
Radius Error and Rotational Error for (Q(x), R(x)) fitted
by coefficients in Table 19 to Maths 14, 18 & 19

| | RadErr | RotErr |
|---|---|---|
| Max = | 0.001584 | 0.009175 |
| Min = | −0.010078 | −0.009175 |
| SumSq = | 0.001556 | 0.001752 |

As FIG. 19 indicates, there is a distinct relationship between f(x) and g(x). It turns out that (f(x)+g(x))/2−x→0, indicating that c1=2−a1. When this relation is put into Math 18, the numbers is Tables 17 & 20 do not change. Nor does the graph. This produces the equations in Math 20. So using the single quadratic taper in all the pot gangs, as in Math 14 and Table 18, for RB=0.163391 and a1=0.205727, produce a radius error of about 2.8% or less, and a rotational error of about 0.7% or less, with a Objective Function value of 0.023538. Whereas using f(x) and g(x) as defined in Maths 14 & 20, with just a₁=0.167093 as a parameter, produces both a radius error and rotational error of about 1% or less, with an equivalent Objective Function value of 0.019906. This makes this approach worth considering.

$$g ( x ) = \{ \begin{matrix}{g}_{1} ( x ) , 0 \leq x \leq 0.5 \\ {g}_{2} ( x ) , 0.5 < x \leq 1\end{matrix} Using {a}_{1} as parameter : {g}_{1} ( x ) = ( 2 - {a}_{1} ) x + 2 ( {a}_{1} - 1 ) {x}^{2} {g}_{2} ( x ) = 1 - {a}_{1} + ( 3 {a}_{1} - 2 ) x + 2 ( 1 - {a}_{1} ) {x}^{2} Provided : 0 \leq {a}_{1} < 1 \qquad Math 20$$

### Gain Curves for Nonlinear Pot Gangs in the U3 Summer/Compensator Circuit

Let h(x) be the taper function for pot gang Pgc, primarily for use in the Claims, and then realize that it will often be one of the previously defined functions. Also, in these cases, the values of QRrad in Table 21 are ignored, and not used to correct the values of Relative Amplitude in Table 2, which are directly taken as the values for V_{HB}. Using Maths 11 & 12, the linear pot gang has already been fitted to the summation-compensation circuit about U3 in FIGS. 5 & 6, with the objective function results listed in Table 17, and plotted for the best candidates in FIGS. 14 & 15. For completeness, FIG. 20 shows the gains calculated from Math 11, M11 Gain, and Math 12, M12 Gain, for P=1 (scaled), R1=0.15, R2=0.2, and RF=0.7 for Math 11 and RF=0.08 for Math 12. M12 Gain is an upside-down parabola, and M11 Gain is a slightly flattened parabola, where the influence of R₁ can be seen at x=0, and the influence of R₂ can be seen at x=1. The maxima and minima tend to remain in the center.

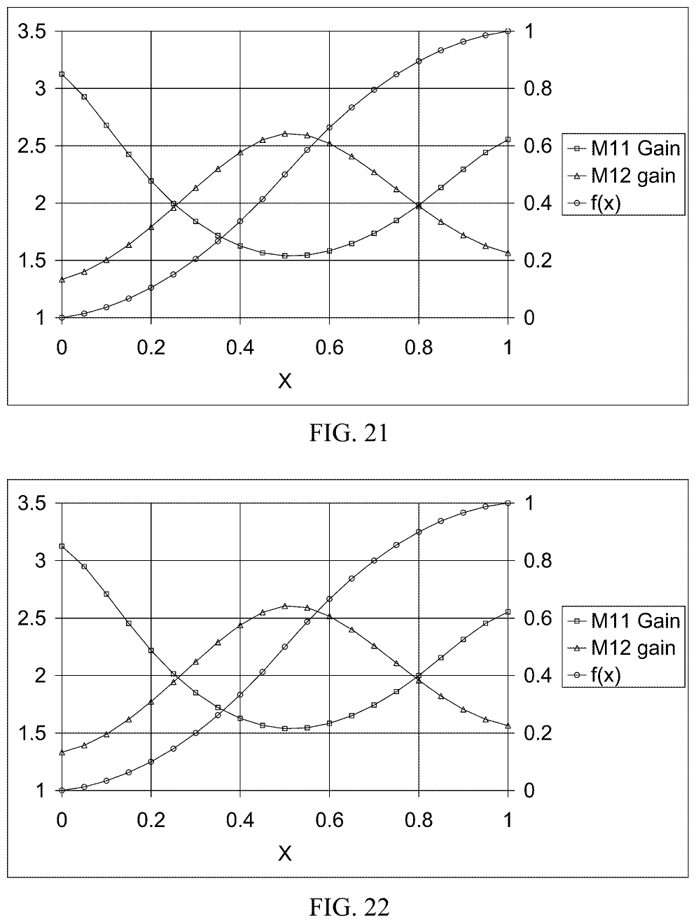

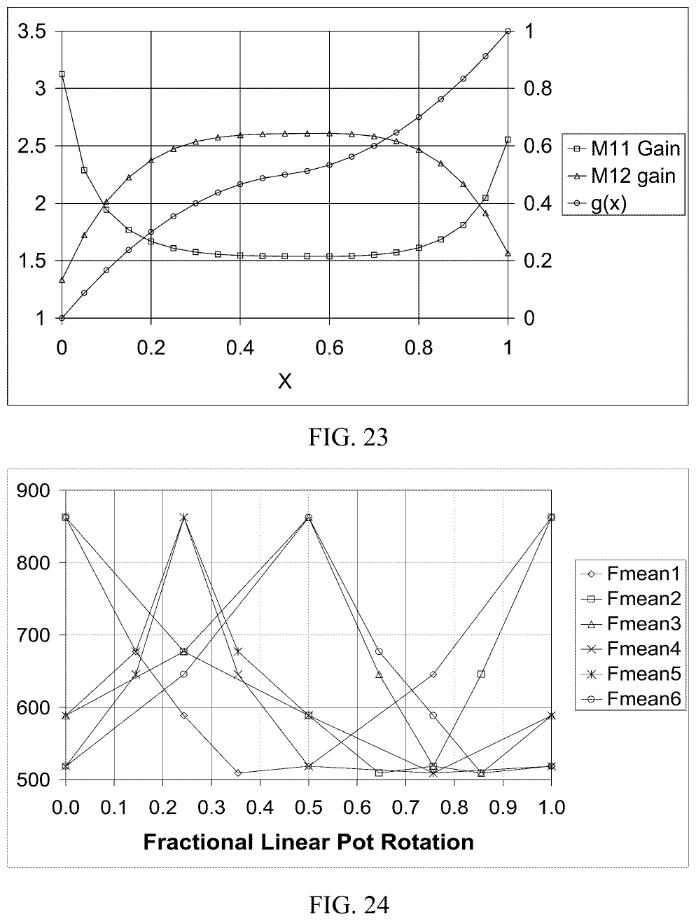

That being said, there are three nonlinear pot gang tapers to consider for the gain curves. The first gang taper is the f(x) S-curve defined in Maths 13 & 14 for the pot with all three gang tapers the same, using scaled values of P=1, R_{B}=0.16339, and a₁=0.20573, listed in Table 18, used in FIGS. 5 & 6. FIG. 21 shows the plot for M11 Gain and M12 Gain against left axis with f(x) against the right, versus the fractional pot rotation, x. M11 Gain and M12 Gain are calculated by substituting f(x) for x in Math 11 and Math 12. The second is the f(x) S-curve defined in Math 14, using scaled values of P=1 and a₁=0.16709 from Table 19, used in the FIG. 18 U1-Buff2 circuits and adapted to FIGS. 5 & 6. FIG. 22 shows a similar plot of the functions, M11 Gain, M12 Gain and f(x). The third nonlinear pot gang taper is the g(x) reverse-S-curve defined in Math 20, using the same scaled values of P=1 and a₁=0.16709 from the second, used in the FIG. 18 adaptation of FIGS. 5 & 6. There are only slight visual differences between FIGS. 21 & 22. FIG. 23 shows a similar plot of these functions, M11 Gain, M12 Gain and g(x). For a gain compensation function, g(x) does not look that promising, but we will see. FIGS. 22 & 23 relate directly to the curves in FIG. 19.

But before these pot tapers can be used in fitting the compensation gain, to get results like Tables 10-15 & 17, we need to have transformations stating the distortion between QRrot and x, as with Table 7 for the linear pot gangs. For the first nonlinear taper, Table 21 shows the results of substituting f(x) for x in Math 7 for Q(x) and Math 8 for R(x) and Math 10 for QRrot. A Solver or What If spreadsheet tool is used to fit x to produce the values of QRrot derived in Tables 5-7. For the second and third non-linear tapers, which use the U1, U2, Buff1 & Buff2 circuits in FIG. 18, Table 22 shows the results of substituting f(x) for x in Math 7 to get Q(x) and substituting g(x) in Math 20 for x in Math 19 to get R(x).

TABLE 21
Conversion from QRrot to x for nonlinear gangs, with
all the same taper, using FIGS. 5 & 6, P = 1, R_{B} =
0.163391 and a₁ = 0.205727, with the (Q, R) radius, QRrad

| QRrot | x | QRrad |
|---|---|---|
| 0.0000 | 0.0000 | 1.0000 |
| 0.1476 | 0.1442 | 0.9779 |
| 0.2500 | 0.2434 | 1.0063 |
| 0.3524 | 0.3550 | 1.0142 |
| 0.5000 | 0.5000 | 1.0000 |
| 0.6476 | 0.6450 | 1.0142 |
| 0.7500 | 0.7566 | 1.0063 |
| 0.8524 | 0.8558 | 0.9779 |
| 1.0000 | 1.0000 | 1.0000 |

For comparison, FIGS. 12 & 13 are replotted in FIGS. 24 & 25 using Table 21. They are no replotted for Table 22 because the differences are so small. For completeness, the adaptation of FIG. 5, using the center-tapped pot gang, Pgb, in FIG. 18, is made to FIG. 6 in FIG. 26.

TABLE 22
Conversion from QRrot to x for nonlinear gangs, using FIG. 18, P =
1 ohm and a₁ = 0.16709, with the (Q, R) radius, QRrad

| QRrot | x | QRrad |
|---|---|---|
| 0.0000 | 0.0000 | 1.0000 |
| 0.1476 | 0.1388 | 0.9944 |
| 0.2500 | 0.2500 | 1.0016 |
| 0.3524 | 0.3612 | 0.9944 |
| 0.5000 | 0.5000 | 1.0000 |
| 0.6476 | 0.6388 | 0.9944 |
| 0.7500 | 0.7500 | 1.0016 |
| 0.8524 | 0.8612 | 0.9944 |
| 1.0000 | 1.0000 | 1.0000 |

Tables 23-25 below show results similar to Table 17, for the three nonlinear taper functions used in pot gang, Pgc, in the summer/compensator circuit in FIGS. 18 & 26. In all four tables, 17, 23-25, the humbucking output for Q(N−B)+R(M+B) and FIGS. 5 & 18 has the best amplitude compensation, and the humbucking output for Q(M+B)+R(N−B) and FIGS. 6 & 26 has the second best amplitude compensation. For those two, Table 23 shows slightly worse results than Table 17 (all linear taper gangs), Table 24 shows slightly better, and Table 25 demonstrate that its approach should not be considered for this invention.

TABLE 23
Results of minimizing the Objective Function =
SUMSQ((Vo(xᵢ) − 2)/2) by varying R₁, R₂ & R_{F}
in FIGS. 18 & 26, using Table 21, the first
nonlinear function, f(x) w/al = 0.20573,
and Maths 11 & 12

| HB Relation | Fit Math 11 to FIG. 18 | Fit Math 12 to FIG. 26 |
|---|---|---|
| Q(N − B) + R(M + N) | 0.20216 | 0.292082 |
| Q(N − B) + R(M + B) | 0.018466 | 0.437127 |
| Q(M + B) + R(N − B) | 0.36066 | 0.037055 |
| Q(M + B) + R(M + N) | 0.36077 | 0.166171 |
| Q(M + N) + R(M + B) | 0.17954 | 0.255171 |
| Q(M + N) + R(N − B) | 0.220739 | 0.195597 |

TABLE 24
Results of minimizing the Objective Function =
SUMSQ((Vo(xᵢ) − 2)/2) by varying R₁, R₂ & R_{F} in
FIGS. 18 & 26, using Table 22, the second nonlinear
function, f(x) w/al = 0.16709, and Maths 11 & 12

| HB Relation | Fit Math 11 to FIG. 18 | Fit Math 12 to FIG. 26 |
|---|---|---|
| Q(N − B) + R(M + N) | 0.202569 | 0.294373 |
| Q(N − B) + R(M + B) | 0.015305 | 0.437096 |
| Q(M + B) + R(N − B) | 0.360691 | 0.033415 |
| Q(M + B) + R(M + N) | 0.36077 | 0.165708 |
| Q(M + N) + R(M + B) | 0.177359 | 0.254756 |
| Q(M + N) + R(N − B) | 0.220643 | 0.195837 |

TABLE 25
Results of minimizing the Objective Function =
SUMSQ((Vo(xᵢ) − 2)/2) by varying R₁, R₂ & R_{F} in
FIGS. 18 & 26, using Table 22, the third nonlinear
function, g(x) w/al = 0.16709 from Math 20, and Maths 11 & 12

| HB Relation | Fit Math 11 to FIG. 18 | Fit Math 12 to FIG. 26 |
|---|---|---|
| Q(N − B) + R(M + N) | 0.173195 | 0.397196 |
| Q(N − B) + R(M + B) | 0.117096 | 0.437195 |
| Q(M + B) + R(N − B) | 0.36109 | 0.16958 |
| Q(M + B) + R(M + N) | 0.360764 | 0.210969 |
| Q(M + N) + R(M + B) | 0.264844 | 0.298976 |
| Q(M + N) + R(N − B) | 0.283408 | 0.28567 |

### Near Perfect Amplitude Compensation for HB Pair and Triple Points

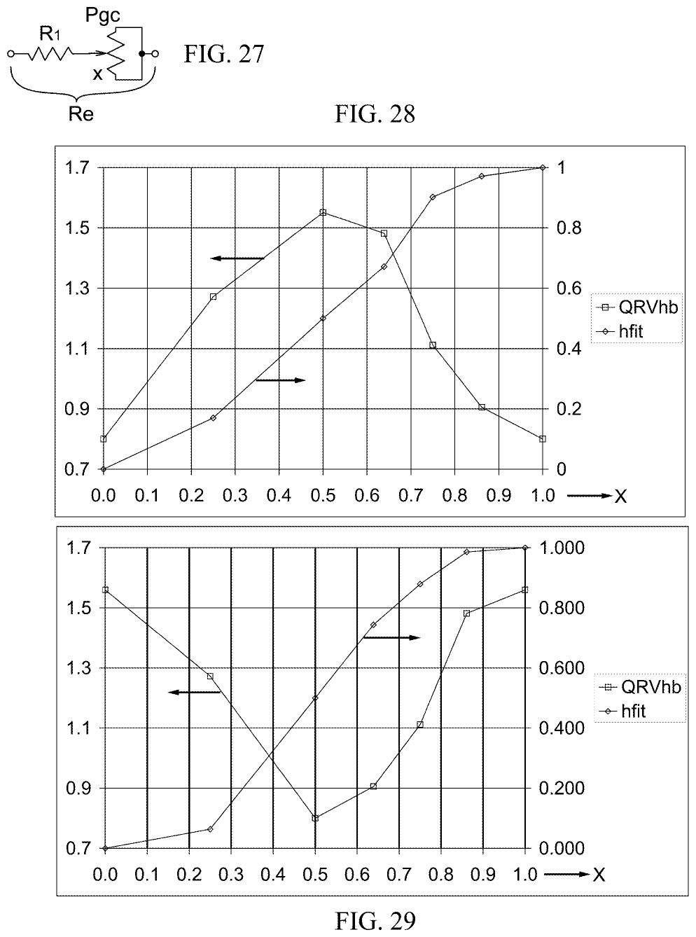

FIG. 27 shows a simplified circuit for pot gang Pgc in FIGS. 5, 6, 18 & 26, where R₁ and R₂ are combined in a single resistor, R₁. Let h(x) be the pot gang transfer function for Pgc in FIG. 18. Let Vhb=Q(x)(N−B)+R(x)(M+B), the most useful combination so far. Because the summing resistors, Rs, in FIG. 18 also form a voltage divider, the input to the plus terminal of U3 is Vhb/2. So the output of U3, Vo=Gain*Vhb/2, where Gain is the feedback gain of U3 in FIGS. 5 & 18 as defined in Maths 21 & 22, or the gain as defined for FIGS. 6 & 26 in Maths 21 & 25. Maths 21-24 pick R_{F} and R₁ to assure that h(0)=0, h(0.5)=0.5 and h(1)=1 in FIGS. 5 & 18, modified by FIG. 27, where Gain is the gain of U3 with R_{F} and Re.

$$Re = h ( x ) ( 1 - h ( x ) ) P + {R}_{1} \qquad Math 21$$

$$Gain = \frac{{R}_{F} + Re}{Re} = \frac{Vo}{Vhb / 2} \\ \frac{Vo}{Vhb} = \frac{Gain}{2} = \frac{{R}_{F} + Re}{2 Re} \qquad Math 22$$

$$For x = 0 : Re = {R}_{1} \\ \frac{Vo}{Vhb} = \frac{{Gain}_{0}}{2} = \frac{{R}_{F} + {R}_{1}}{2 {R}_{1}} \\ {R}_{F} = ( {Gain}_{0} - 1 ) {R}_{1} \qquad Math 23$$

$$For x = 0.5 : Re = {R}_{1} + P / 4 \\ \frac{Vo}{Vhb} = \frac{{Gain}_{0.5}}{2} = \frac{( {Gain}_{0} - 1 ) {R}_{1} + {R}_{1} + P / 4}{2 ( {R}_{1} + P / 4 )} \\ {R}_{1} = \frac{( {Gain}_{0.5} - 1 ) P}{4 ( {Gain}_{0} - {Gain}_{0.5} )} \qquad Math 24$$

Maths 21 & 25-27 pick R_{F} and R₁ to assure that h(0)=0, h(0.5)=0.5 and h(1)=1 in FIGS. 6 & 26, where Gain is the gain of U3 with R_{F} and Re.

$$Gain = \frac{{R}_{F} + R e}{{R}_{F}} = \frac{Vo}{Vhb / 2} \\ \frac{Vo}{Vhb} = \frac{Gain}{2} = \frac{{R}_{F} + Re}{2 {R}_{F}} \qquad Math 25$$

$$For x = 0 : Re = {R}_{1} \\ \frac{Vo}{Vhb} = \frac{{Gain}_{0}}{2} = \frac{{R}_{F} + {R}_{1}}{2 {R}_{F}} \\ {R}_{F} = \frac{{R}_{1}}{( {Gain}_{0} - 1 )} \qquad Math 26$$

$$For x = 0.5 : Re = {R}_{1} + P / 4 \\ \frac{Vo}{Vhb} = \frac{{Gain}_{0.5}}{2} = \frac{{R}_{1} / ( {Gain}_{0} - 1 ) + {R}_{1} + P / 4}{2 {R}_{1} / ( {Gain}_{0} - 1 )} \\ {R}_{1} = \frac{( {Gain}_{0} - 1 ) P}{4 ( {Gain}_{0.5} - {Gain}_{0} )} \qquad Math 27$$

For the P-90 pickup used here, 0.80≤Vhb≤1.56. Suppose we want all seven outputs from the U3 circuit, for the Vhb=RelAmp*QRrad=RelAmp*SQRT(Q²+R²), to show at the output of U3 as Voset=2. For this example, we use Vhb=Q(x)(N−B)+R(x)(M+B), from Tables 2 & 11, where we have measured values of RelAmp for the six humbucking pairs and triples from switched circuits. As FIG. 14 shows, Vhb peaks for RelAmp=1.56 at x=0.5. For this exercise, we choose the arguably best Q-R generation circuit in FIG. 18, with QRrad values from Table 22, and generate columns in a spreadsheet. The first three columns are x, Fmean (not used) and RelAmp, where x is generated from QRrot from FIG. 22. The next three columns are QRrad, QRVhb=RelAmp*QRrad, and needed gain, Gni, from Math 28.

$${Gn}_{i} = \frac{{R}_{F} + {Re}_{i}}{{Re}_{i}} = \frac{{R}_{F} + h ( {x}_{i} ) ( 1 - h ( {x}_{i} ) ) P + {R}_{1}}{h ( {x}_{i} ) ( 1 - h ( {x}_{i} ) ) P + {R}_{1}} ⇒ {hp}_{i} = h ( {x}_{i} ) ( 1 - h ( {x}_{i} ) ) = \frac{{R}_{F} + ( 1 - G {n}_{i} ) {R}_{1}}{( {Gn}_{i} - 1 ) P} \\ {hpfit}_{i} = {hfit}_{i} ( 1 - {hfit}_{i} ) , {hperr}_{i} = {hpfit}_{i} - {hp}_{i} \\ {Refit}_{i} = {hpfit}_{i} P + {R}_{1} \qquad Math 29$$

$${Gfit}_{i} = \frac{{R}_{F} + {Refit}_{i}}{{Refit}_{i}} \\ {Vofit}_{i} = {Gfit}_{i} \frac{{QRVhb}_{i}}{2} \qquad Math 30$$

The next column is hpᵢ, calculated from the values of Gnᵢ, R_{F}, R₁ and P, according to Math 29, followed by columns of hfitᵢ, hpfitᵢ and hperrᵢ. The columns of Refitᵢ, Gfitᵢ and Vofitᵢ, according to Math 30. The xᵢ column is copied to the hpfiti column for starting values. Then in each row, i, a Solver or What If spreadsheet tool is used to vary hpfitᵢ to drive hperrᵢ to zero. The resulting values of Vofitᵢ then equal Voset to within an error of about 1.e−5. The plot of hfitᵢ versus xᵢ, as shown in FIG. 28, fits h(x) exactly at seven points, for scaled values of P=1, R_{F}=0.651898 and R₁=0.162974. If a 10 k pot is used for P, then the other two values are multiplied by 10 k. Maths 21, 25-28, 31 & 32 apply to FIGS. 6 & 26, modified by FIG. 27. FIG. 29 shows the results. Both FIGS. 28 & 29 do not graph Vofitᵢ because it is merely a straight line at Vofit=2.

$${Gn}_{i} = \frac{{R}_{F} + {Re}_{i}}{{R}_{F}} = \frac{{R}_{F} + h ( {x}_{i} ) ( 1 - h ( {x}_{i} ) ) P + {R}_{1}}{{R}_{F}} ⇒ {hp}_{i} = h ( {x}_{i} ) ( 1 - h ( {x}_{i} ) ) = \frac{( {Gn}_{i} - 1 ) {R}_{F} - {R}_{1}}{P} {hpfit}_{i} = {hfit}_{i} ( 1 - {hfit}_{i} ) , {hperr}_{i} = {hpfit}_{i} - {hp}_{i} \\ {Refit}_{i} = {hpfit}_{i} P + {R}_{1} \qquad Math 31$$

$${Gfit}_{i} = \frac{{R}_{F} + {Refit}_{i}}{{R}_{F}} \\ {Vofit}_{i} = {Gfit}_{i} \frac{{QRVhb}_{i}}{2} \qquad Math 32$$

It turns out that it is not so clear and easy to fit h(x)=aᵢx+a₂x²+ . . . a_{N}x^{N} by minimizing an objective function. It is easy to end up with negative slopes in h(x), which are physically impossible in an analog pot taper, at least by current technology. Or no solution at all. Other mathematical methods exist for fitting piecewise polynomial or bezier curves to known points that might be employed. The question remains as to whether or not a pot maker can match the curves for the right price. FIGS. 28 & 29 show seven known points with six straight-line segments in between. The straight-line-segment approach can be used to fit the other polynomial curves developed here. One can reasonably assume that this is possible to produce with current pot technology, if not necessarily economic. One might reasonably suppose that a pot manufacturer would do it for a large enough order.

### Tone Controls

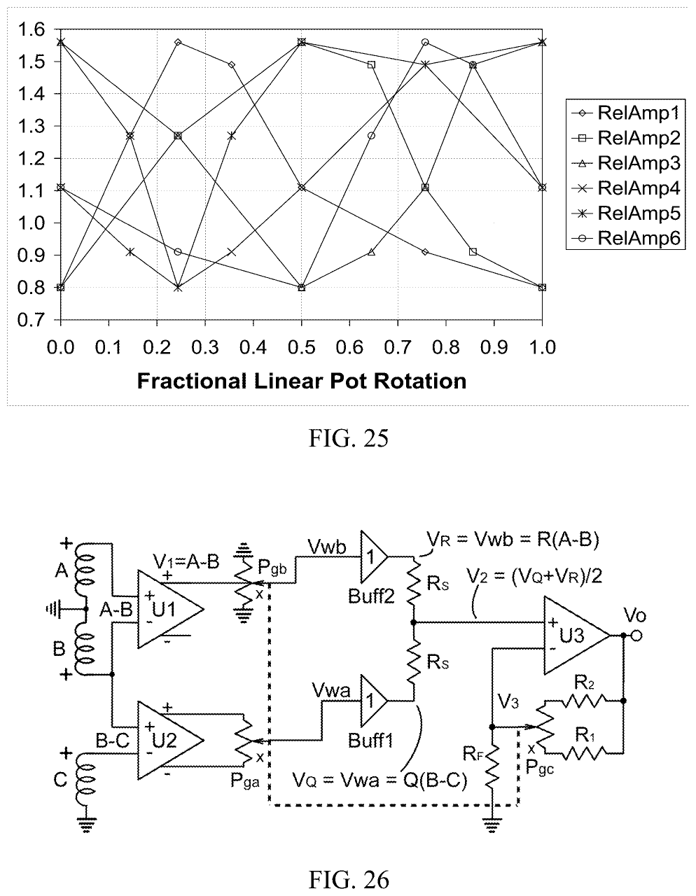

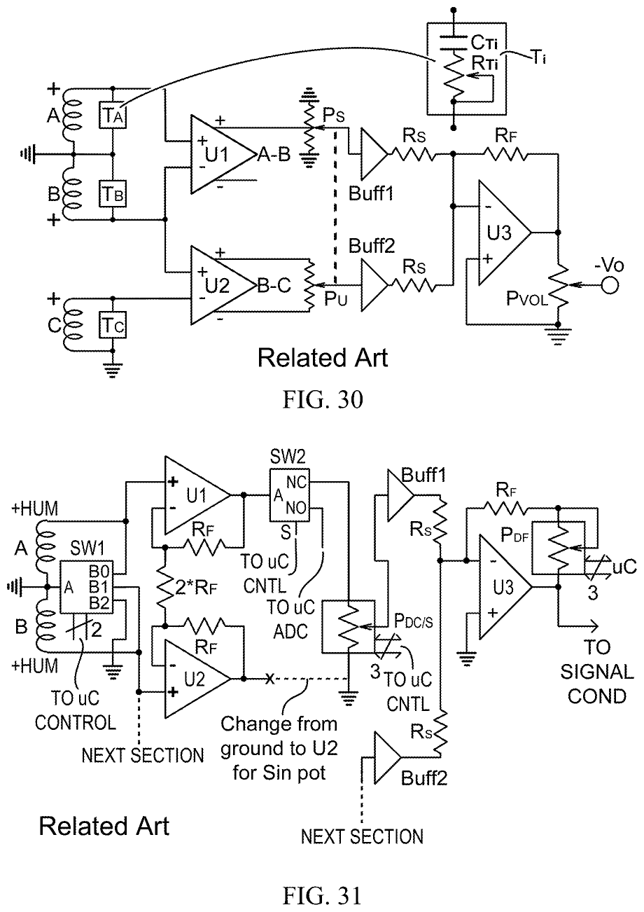

Briefly, FIG. 30 is related art, FIG. 25 in NP patent application Ser. No. 16/985,863, showing how each pickup can have a traditional tone circuit. It also follows from FIGS. 9-11 in U.S. Pat. No. 10,380,986. Standard tone controls used on the outputs of active circuits cannot have the same interaction with pickup, including resonant peaking at higher frequencies. In this invention, one must obtain such tonal effects by putting tone circuits directly across individual sensors.

### Digital Pots and FFTs

A prominent maker of commercial and guitar pots responded to a query about its estimated price and minimum quantity for an order of special-order pot with custom tapers. It's standard pots would run $1 to $3 each, custom taper pot would run up to three times as much, and the minimum order could be 20 k, for a possible total order of up to $180,000. It was clearly referring to single-gang pots, not three-gang. A few years ago, surface-mount device digital pots with 256 taps, common values of 10 k, 50 k and 100 k, with serial digital input controls could be bought for $0.70 to less than $3.00 each in minimum orders of 1 each. To the practical limits of its repeatability and accuracy, any digital pot can have any taper in software, even non-physical tapers. It remains to integrate a micro-controller or microprocessor into a guitar to take advantage of this flexibility. Others claim to have done so, including Elion (U.S. Pat. No. 5,140,890, 1992), and Ball, et al. (U.S. Pat. No. 9,196,235, 2015; U.S. Pat. No. 9,640,162, 2017), but without addressing this particular situation.

FIG. 31 is related art, FIG. 23 in NP patent application Ser. No. 16/985,863, from which this invention continues. It shows U1, as in in FIGS. 5, 6, 18 & 26, replaced by two op-amps, U1 and U2, forming a differential amplifier, pot gang Pgb in those figures replaced by a digital pot, P_{DC/S}, and a digital pot, P_{DF}, replacing the circuit using pot gang Pgc about the summer/compensator amplifier, U3. Most if not all digital pots are linear, with taper functions imposed only by software. FIG. 30 shows only one part of the circuit for the pseudo-sin/cosine functions, the other called out as the “NEXT SECTION”. Digital pot P _{DC/S} is shown used as a cosine pot. To be used as a sine pot, its lower terminal must be moved from ground to the output of U2.

If the micro-controller or micro-processor that drives the digital pots has sine and cosine functions in it math processing unit (MPU), then they can be used directly both in driving digital pots in this application, or in calculating FFTs of both single sensors and humbucking pair signals, as Baker discussed in previous publications and patent applications. But the previous NPPA from which this continues, 16/985,863 (Baker, Aug. 5, 2020), sine and cosine were approximated by a four-function-plus-square-root MPU. The functions developed here don't require a square root function to approximate sine and cosine.

Using a₁ as parameter
where 0≤x≤1 is the fractional pot rotation

f₁(x)=a₁x+2(1−a₁)x², 0≤x≤0.5

f₂(0.5+u)=0.5+f₁(0.5−u), 0≤u≤0.5, 0.5≤(x=0.5+u)≤1

Q(x)=2f(x)−1

g₁(x)=(2−a₁)x+2(a₁−1)x², 0≤x≤0.5

g₂(0.5+u)=g₁(0.5−u), 0≤u≤0.5, 0.5≤(x=0.5+u)≤1

R(x)=2g(x)

f₁(x)+g₁(x)=2x, Q(x)+R(x)=4x−1 Math 33

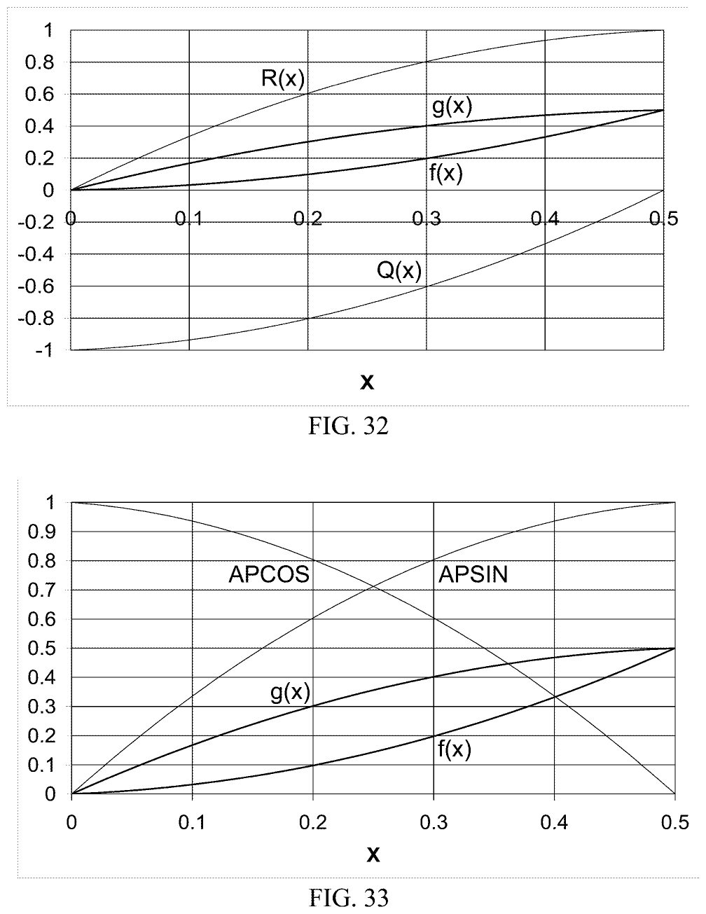

Reconsider Maths 7, 13, 14, 19 & 20 recast as Math 33, with a change to the definition of g₂(x). FIG. 32 shows these relations plotted from x=0 to 0.5 for a₁=0.15. Due to symmetry, it is clear that only the first half of the functions f₁(x) and g₁(x) need to be computed and stored in a lookup table. The previous definitions of f₂(x) in Math 14 and g₂(x) in Math 20 need not be used. This is simplified further in Math 34. When the parameter a₁ is about 0.15, −0.008<(QRrad−1)<0.008, and −0.01<(QRrot−x)<0.01 for 0≤x≤0.5. Since the functions have symmetry about x=0.5, so do the errors.

Using a₁ as parameter
where 0≤x≤1 is the fractional pot rotation

Q₁(x)=(2(1−a₁)x+a₁)2x−1, 0≤x≤0.5

Q₂(0.5+u)=−Q₁(0.5−u), 0≤u≤0.5, 0.5≤(x=0.5+u)≤1

R₁(x)=4x−1−Q₁(x)

R₂(0.5+u)=R₁(0.5−u), 0≤u≤0.5, 0.5≤(x=0.5+u)≤1 Math 34.

In the previous invention, NP patent application Ser. No. 16/985,863, the pseudo-sine and -cosine functions required the four basic calculator functions plus square root. This invention needs only the four basic math functions, plus, minus, multiply and divide, to calculate the piecewise-polynomials used as orthogonal functions instead of sine and cosine. This allows a wider range of available micro-controllers and micro-processors to be used. And depending upon what accuracy in spectral analysis is truly needed to make a credible and audible distinction between tones, these piecewise-polynomial pseudo-functions might also be used in Fourier Transforms, both forward and inverse.

Using a₁ as parameter

f(x)=(2(1−a₁)x+a₁)2x

apcos(x)=1−2f(x), 0≤x≤0.5

apsin(x)=2(2x−f(x)), 0≤x≤0.5 Math 35.

Math 35 shows the functions in Math 33 & 34 reconfigured to produce an approximate sine, apsin, and an approximate cosine, apcos, as plotted for one-quarter cycle in FIG. 33. If a1=0.15, then −0.016<(apcos(x)−cos(πx))<0.027, and the same is true of (apsin(x)−sin(πx)). But a Fast Fourier Transform (FFT), as described in Brigham (1974, p 164), requires full cycle definitions of sine and cosine. In this case, they have to be defined for 0≤x≤2 to get a full cycle. Using x instead of angle allows one to dispense with the need for a stored value of Pi. Math 36 shows full-cycle definitions for apsin(x) and apcos(x), taking advantage of the remaining parts of the curves are simply transformations of the first quarter-cycle. And the error between apsin and sin and between apcos and cos is still between −0.016 and 0.27 for a₁=0.15. For a₁=0.1857667, the positive and negative errors are effectively equal and about ±0.02126. This is obtained by defining an objective function equal to the maximum error (>0) plus the minimum error (<0), and varying the parameter a₁ until the objective function goes to zero.

$$U sing {a}_{1} as parameter f ( x ) = ( 2 ( 1 - {a}_{1} ) x + {a}_{1} ) 2 x 0 \leq x \leq 0.5 \{ \begin{matrix}apco s ( x ) = 1 - 2 f ( x ) \\ apsi n ( x ) = 2 ( 2 x - f ( x ) )\end{matrix} 0.5 \leq x \leq 1 \{ \begin{matrix}apco s ( x ) = 2 f ( 1 - x ) - 1 \\ apsi n ( x ) = 2 ( 2 ( 1 - x ) - f ( 1 - x ) )\end{matrix} 1 \leq x \leq 1.5 \{ \begin{matrix}apco s ( x ) = 2 f ( x - 1 ) - 1 \\ apsi n ( x ) = 2 ( f ( x - 1 ) - 2 ( x - 1 ) )\end{matrix} 1.5 \leq x \leq 2 \{ \begin{matrix}apco s ( x ) = 1 - 2 f ( 2 - x ) \\ apsi n ( x ) = 2 ( f ( 2 - x ) - 2 ( 2 - x ) )\end{matrix} \qquad Math 36$$

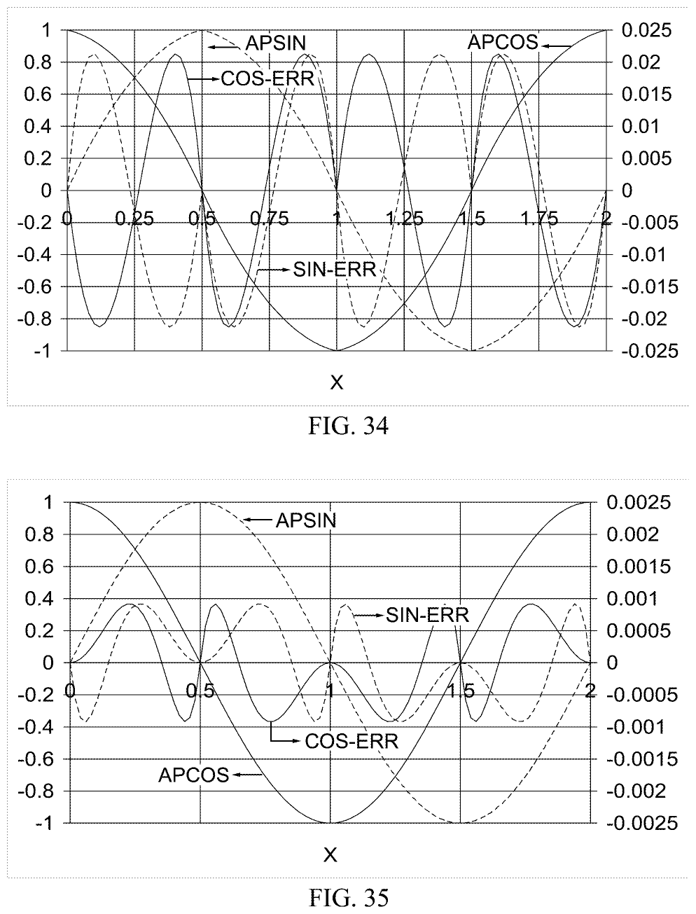

FIG. 34 shows one-cycle plots of apcos(x) (solid line) and apsin(x) (dashed line) against the left axis, and the errors in cosine (solid line) and sine (dashed line) against the right axis. One wouldn't want to use this approximation for sine and cosine in structural loading calculations, bringing astronauts home from the Moon, or diverting any extinction-level-event asteroid from the Earth. But for generating the FFT spectra of electric guitar signals, it just might do. One can fit a quadratic equation to apcos(x) directly, as shown in Math 37. But it leaves no fitting parameter and the fit only good to plus or minus about 6%.

f(x)=a₀+a₁x+a₂x²

f(0)=1⇒a₀=1

f′(0)=0⇒a₁=0

f(0.5)=1⇒a₂=−4

∴f(x)=1−4x² Math 37.

Following work done in NP patent application Ser. No. 16/985,863, it is possible to get a better fit using an approximating polynomial in terms of x, x² and x⁴. Math 38 shows the derivation, and Math 39 shows the expansion from a quarter-cycle to a full cycle. For a₂=−4.896, making a₄=3.584, the error in apsin(x) and apcos(x) is about ±0.00092, considerably better than for Math 36. FIG. 35 shows one-cycle plots of apcos(x) (solid line) and apsin(x) (dashed line) against the left axis, and the errors in cosine (solid line) and sine (dashed line) against the right axis. Note that the right axis is ten times smaller than the right axis in FIG. 34, and the apsin and apcos functions are a bit less pointy at the +1 and −1 extremes. This should be more than sufficient for calculating FFTs for guitar signals.

f(x)=a₀+a₁x+a₂x²+a₄x⁴

f(0)=1⇒a₀=1

f′(0)=0⇒a₁=0

f(0.5)=1⇒a₄=−16−4a₂

∴Using a₂ as parameter

f(x)=1+a₂x²−(16+4a₂)x⁴ Math 38.

Using a₂ as parameter

$$f ( x ) = 1 + {a}_{2} {x}^{2} - ( 16 + 4 {a}_{2} ) {x}^{4} 0 \leq x \leq 0.5 \{ \begin{matrix}apcos ( x ) = f ( x ) \\ apsin ( x ) = f ( 0.5 - x )\end{matrix} 0.5 \leq x \leq 1 \{ \begin{matrix}apco s ( x ) = - f ( 1 - x ) \\ apsi n ( x ) = f ( x - 0.5 )\end{matrix} 1 \leq x \leq 1.5 \{ \begin{matrix}apco s ( x ) = - f ( x - 1 ) \\ apsi n ( x ) = - f ( 1.5 - x )\end{matrix} 1.5 \leq x \leq 2 \{ \begin{matrix}apco s ( x ) = f ( 2 - x ) \\ apsi n ( x ) = - f ( x - 1.5 )\end{matrix} \qquad Math 39$$

### Preferred Embodiments

To recap, this invention presents circuit embodiments using a 3-gang pot to mix and compensate two signals, to produce an output of approximately uniform volume, despite amplitude variations due to phase cancellations between the two signals. One gang, Pga, physically simulates a pseudo-sine function, Q(x). A second gang, Pgb, physically simulates a pseudo-cosine function, R(x). Where 0≤x ≤1 is fractional pot rotation, the angular origin of functions sit at the center of the pot rotation, x =0.5 The part of the circuit with Pgb has two embodiments. The first embodiment uses a resistor, R_{B}, in series with the wiper, compensated by the gain of a buffer amplifier. The second embodiment uses a gang with a center-tapped input and no series resistor, with the wiper connected to a unit-gain buffer amplifier.

The third gang, Pgc, modifies the gain of a summer/compensator op-amp, U3, in one of either two configurations. One configuration puts the gang in a circuit between the op-amp output and minus input, to produce the highest gain at x=0.5. The second configuration puts the gang between the minus input and signal ground, to produce the lowest gain at x=0.5. The Pgc circuit has two embodiments. One has two different resistors, R₁ & R₂, connected to the end terminals of the pot, then connected to each other, forming with gang Pgc a variable resistor between the pot wiper and the R₁-R₂ connection. The other connects the end terminals of gang Pgc together, and connects a single resistor, R1, to either the pot wiper or the end terminals, forming with Pgc a variable resistor.

The physical pot taper functions, f(x) for Pga, g(x) for Pgb and h(x) for Pgc, can be the same or different, can be linear, piecewise-polynomial or segmented straight lines between known points. The resistors, gains and taper functions are chosen and designed to minimize three things: 1) the error between the vector (Q(x),R(x)) and the unit vector in the QR-plane; 2) the error between x and the normalized angular rotation of vector (Q(x),R(x)), that rotation being from 0 at (−1,0) to ½ at (0,1) to 1 at (1,0); and 3) the amplitude variations in the combined output signal due to phase cancellations between the two input signals, to produce a constant amplitude with the rotation of the pot at the output of the summer/compensator. These circuits can also be cascaded to add more matched pickups in electric guitars.

In reality, the preferred embodiment is the one that can produce the least radial, rotational and amplitude error at the price one can best afford. This invention allows a patent licensee to start with linear pots and move up with market demand. Otherwise, if price is no object, the last example presented here, with near-perfect output amplitude, looks to be the best.

Here, pot tapers have been shaped to provide the closest physical approximations one can get sine and cosine functions in the manipulations of gains in the circuits. This work and previous work done on U.S. NP patent application Ser. No. 16/986,863, suggest better approximations for approximate sine and approximate cosine functions, or “apsin” and “apcos”. These can be used in three digital pots in and equivalent mixing circuit, driven by programmable processors with simple four-function math processing units (MPUs). These must be considered because of the much larger expense of making and buying custom-taper three-gang potentiometers. Digital pots cost little or no more and can even have non-physical tapers, determined by software. Digital pots driven by a programmable processor also offer what mechanical pots cannot, the ability of the user to put a particular sequence of favorite tones in whatever order the user likes, using a digital user interface.

These apsin and apcos functions can also be optimized and used to generate FFT spectral analyses of the input signals. Two embodiments are provided. One takes a quarter-cycle fit to apcos, using a second-order polynomial with one fitting parameter, and generates all four quarter-cycles of both apcos and apsin. Its error in fitting cosine and sine is about ±2.1 percent The other uses a fourth-order polynomial with one fitting parameter to generate all four quarter cycles of apcos and apsin from one quarter-cycle of apcos. Its error in fitting cosine and sine is about ±0.092%. Both embodiments have been optimized by varying the fitting parameters so that the extreme +error equals the extreme −error across the entire cycle of the functions. With a good complex-value FFT analysis of the input signals, the output for any point in the mixing process can be predicted and used to design the gain curve in the summer/compensator stage.

Along with NP patent application Ser. No. 16/985,863, this invention provides a usable pathway to investigate the linear mixing of humbucking pair signals in electric stringed instruments. A licensee can use an inexpensive linear 3-gang pot to see what it is like to get the outputs for all the possible switched humbucking circuits using three hum-matched sensors. Then, if that looks and sounds good, the licensee can consider whether to invest in custom three-gang potentiometers, or to invest in putting a micro-controller or micro-processor into a guitar to take advantage of the ability to order favorite tones to the user's preference. The licensee can also investigate using more hum-matched pickups, up to the number that will fit underneath the strings. For J number of hum-matched (generally single-coil, but also dual coil humbucking) pickups, there are J−1 number of humbucking pairs and J−2 number of necessary three-gang controls, whether mechanical or solid-state digital.

I claim the following, and as a pro se inventor with limited resources request the help of the patent examiner, according to both the spirit and letter of the mpep, to state these claims defensibly and correctly: I hereby Claim:

1. (Independent) An active and powered electronic circuit module for linearly mixing two or more input signals, at least one of said input signals being differential, and compensating the amplitude of the mixed output for amplitude variations due to phase cancellations between the two said input signals, based upon a either a mechanical 3-gang pot or three digital pots, comprised of:
a. a first pot gang or digital pot, designated as Pga, associated with a first input signal, the circuits associated with said Pga effectively multiplying said first input signal by a first function, −1≤Q(x)≤1, where 0≤x≤1 is the physical fractional rotation of a mechanical pot, or the normalized virtual rotation of a digital pot, and said Q(x) is a pseudo-sine function with Q(0)=−1, Q(½)=0 and Q(1)=1, followed by a first buffer amplifier of gain one, designated as Buff1; and
b. a second pot gang or digital pot, designated as Pgb, associated with a second input signal, the circuits associated with said Pgb effectively multiplying said second input signal by a second function, 0≤R(x)≤1, where said R(x) is a pseudo-cosine function, orthogonal to said Q(x), with R(0)=R(1)=0 and R(½)=1 , followed by a second buffer, designated as Buff2, of gain G, such that any deficiency in said Pgb circuits that makes R(½)<1 is eliminated; and
c. a third pot gang or digital pot, designated as Pgc, acting as part of the feedback circuit of a summer/compensator circuit, in which said summer/compensator adds the output signals of the first two said circuits using said Pga and Pgb, and at least partially compensates for amplitude variations in said mixed first and second input signals, due to phase cancellations between said first and second input signals, the compensation being due to variations in the gain of said summer/compensator circuit due to the action of said Pgc, such that the output amplitude of said summer/compensator circuit remains relatively level with variations in x, compared to its input; and
d. said circuit module with three pot gangs or digital pots being designed so that more than one such circuit module may be combined to accommodate three or more of said input signals; and
e. said orthogonal signals, Q(x) and R(x), respectively form the basis for approximate full-cycle sine and cosine functions, apsin and apcos, for the approximate and practical calculation of forward and reverse spectral transforms of said input signals and said output signals, using a programmable processor with at least the basic four math functions, add, subtract, multiply and divide.

2. An embodiment as recited in claim 1, wherein said first and second pot gangs and said associated circuits physically simulate a pseudo-sine function with said Pga and associated circuits, and physically simulate a pseudo-cosine function with said Pgb and associated circuits, by with the rotation of said pot, where 0≤x≤1 is the normalized fractional rotation of said pot in its active region, such that:
a. said pseudo-sine function, designated here as Q(x) and associated with said Pga, traverses normalized function values of −1 at a first end of the rotation of said pot to 0 at the middle of said pot rotation to +1 at the second end of said pot rotation; and
b. said pseudo-cosine function, designated here as R(x) and associated with said Pgb, traverses normalized function values of 0 at said first end of said pot rotation to 1 at the middle of said pot rotation to 0 at the end of said pot rotation; and
c. said Q(x) and R(x) are functionally and at least approximately orthogonal in the region 0≤x≤1; and
d. the values of the circuit elements associated with said pot gangs, and tapers of said pot gangs adjusted the vector radius of (Q(x),R(x)) in the QR-plane, designated as QRrad=SQRT(Q²+R²), such that the radial error, QRrad−1, is minimized with respect to the unit radius; and
e. the values of the circuit elements associated with said pot gangs, and the tapers of said pot gangs, are adjusted to minimize the difference, designated as rotational error, between the normalized fractional pot rotation, x, and the normalized rotational angle of the vector (Q(x),R(x)) in the QR-plane, designated as QRrot and related to arctan(R(x)/Q(x))/Pi, starting at zero angle the first end of the pot rotation, x=0, and increasing positively with x, to a value of 1 at x=1; and
f. said digital pots, when used instead of said mechanical pot gangs, function in the same manner, where x is a virtual rotation.

3. An embodiment as recited in claim 1 wherein said summer/compensator is comprised of:
a. an operational amplifier, designated here as U3, with the outputs of said buffer amplifiers summed through two equal resistors, R_{S}, at its positive differential input; and
b. the third of said pot gangs, designated here as Pgc, forming a variable resistor with one or more resistors, in one of two ways, such that:
i. resistors R₁ and R₂ being connected together, with the other end of said R₁ being connected to a first terminal of said Pgc, at the x=0 rotational end, and said R₂ being connected to a second terminal said Pgc, at the x=1 rotational end, the circuit between the wiper of said Pgc and the common connection of said R₁ and R₂ forming a variable resistor, Re; or
ii. said Pgc having its end terminals connected together and a single resistor, R1, connected in series with it, either to said interconnected end terminals or to said wiper, the combination forming a variable resistor, Re; and
c. said Re variable resistor being connected together with a third resistor, designated here as R_{F}, to form one of two feedback circuits, such that:
i. the first of said feedback circuits has said resistor R_{F} connected between the operational amplifier output and its negative differential input, said negative differential input is connected to ground through said Re; or
ii. the second of said feedback circuits has said Re connected from the output of said operational amplifier to the negative input of said operational amplifier, and said negative input is connected to ground through said R_{F}; and
d. the values of said one or more resistors connected to said Pgc and said U3 are adjusted as parameters to compensate, at least in part, for any differences in the amplitude of the output signal due to any phase cancellations in the combinations of said input signals, by increasing gain for weaker signal levels, such that the output amplitude tends to be even with the rotation of said three-gang pot, or with the virtual rotation of said three digital pots.

4. An embodiment as recited in claim 2, wherein said pseudo-sine function Q(x) is physically created by connecting said pot gang Pga to a first input signal, which is differential, with a negative input signal and a positive input signal, both of which carry the full amplitude of the signal with respect to signal ground, wherein a first terminal of said Pga is connected to said negative input signal and a second terminal of said Pga is connected to said positive input signal, and the wiper of said Pga is the output producing a signal of Q(x) times said first input signal, which is connected directly to a first buffer amplifier, said Buff1 with a gain of one, and the taper of said Pga is physically formed to approximate a function, f(x), which includes the linear taper, f(x)=x, such that:
a. f(0)=0; f(0.5)=0.5; f(1)=1; and
b. the first derivative with respect to x of f(0) equals the first derivative with respect to x of f(1) and is greater than or equal to zero and less than 1; and
c. f(x) has symmetry, such that the line between f(0.5−u) and f(0.5+u), 0≤u≤0.5, always passes through f(0.5)=0.5; and
d. nowhere in the range 0≤x≤1 may the first derivative of f(x) with respect to x be less than zero.

5. An embodiment as recited in claim 2, wherein a circuit composed of a resistor, R_{B}, said second pot gang, Pgb, and the gain, of said second buffer, Buff2, physically simulate said pseudo-cosine function, R(x), with:
a. at least one of two versions of said second input signal are available, either the positive or the negative of said input signal, each carrying the full amplitude of said second input signal with respect to signal ground, and R_{B} is connected between either of said signed versions of the second of said input signals and the wiper of said pot gang Pgb, the end terminals of Pgb being grounded to the signal ground, so that the wiper of said Pgb forms a variable resistance between it and ground, varying from zero to half the total resistance of Pgb between the end terminals, and the wiper being connected as well to the input of said Buff2, with the taper of said Pgb is physically formed to approximate a function, g(x), which includes the linear taper, g(x)=x, such that:
i. g(0)=0; g(0.5)=0.5; g(1)=1; and
ii. the first derivative with respect to x of g(0) equals the first derivative with respect to x of g(1), and is greater than or equal to zero; and
iii. g(x) has symmetry, such that the line between g(0.5−u) and g(0.5+u), 0≤u≤0.5, always passes through g(0.5)=0.5; and
iv. the value of R_{B} and the parameters defining g(x) are parameters in minimizing the values of QRrad(x)−1 and QRrot(x)−x; and
v. nowhere between 0≤x≤1 may the first derivative of g(x) with respect to x be less than zero; and
b. said gain, of said Buff2 is set so that when the wiper of said Pgb is set near the center of its range to create a maximum resistance for said variable resistor, the output of said Buff2 equals said second input signal, so that said R(½)=1.

6. An embodiment as recited in claim 2, wherein said pot gang Pgb has a center-tapped input connected to either a positive or a negative version of the second of said input signals, either of said versions carrying the full amplitude of said second input signal with respect to signal ground, the end terminals of Pgb being grounded to the signal ground, and the wiper connected to the input of said buffer amplifier, Buff2, which has a gain of one, wherein the Pgb taper is a nonlinear function, g(x), specifically excluding the linear taper, g(x)=x, such that:
a. g(0)=0; g(0.5)=0.5; g(1)=1; and
b. the first derivative with respect to x of g(0) equals the first derivative with respect to x of g(1); and
c. g(x) has symmetry, such that the line between g(0.5−u) and g(0.5+u), 0≤u≤0.5, always passes through g(0.5)=0.5; and
d. the parameters defining g(x) are parameters in minimizing the values of QRrad(x)−1, and QRrot(x)−x; and
e. nowhere between 0≤x≤1 may the first derivative of g(x) with respect to x be less than zero.

7. An embodiment as recited in claim 6, wherein the taper function f(x) for said Pga and the taper function g(x) for said Pgb, when said Pgb is has a center-tapped input, are complimentary, such that:
a. f(x)+g(x)=2x; and
b. f(0)=g(0)=0;f(0.5)=g(0.5)=0.5; f(1)=g(1)=1; and
c. f(x) has symmetry, such that the line between f(0.5−u) and f(0.5+u), 0≤u≤0.5, always passes through f(0.5)=0.5; and
d. g(x) has symmetry, such that the line between g(0.5−u) and g(0.5+u), 0≤u≤0.5, always passes through g(0.5)=0.5; and
e. the parameters defining g(x) are parameters in minimizing the values of QRrad(x)−1, and QRrot(x)−x; and
f. nowhere between 0≤x≤1 may the first derivative with respect to x of either f(x) or g(x) be less than zero.

8. An embodiment as recited in claim 2, wherein the taper function f(x) for said Pga and the taper function g(x) for said Pgb are the same, have a single fitting defining parameter, a₁, and have the form:
a. for 0≤x≤0.5, f(x)=g(x)=a₁x+2(1−a₁)x²; and
b. for 0.5≤x≤1, f(x)=g(x)=a₁−1+(4−3a₁)x+2(a₁−1)x².

9. An embodiment as recited in claim 8, wherein
a. said pot gang Pgb has a center-tapped input connected to either the positive or the negative of the second of said input signals, either the positive or the negative signal carrying the full amplitude of said second input signal with respect to signal ground, the end terminals of Pgb being grounded to the signal ground, and the wiper connected to the input of said buffer amplifier, Buff2, which has a gain of one; and
b. g(x) is not the same as f(x), but is defined by the same fitting parameter, a₁, where 0≤a₁<1, and has the form:
i. for 0≤x≤0.5, g(x)=(2−a₁)x+2(a₁−1)x²; and
ii. for 0.5≤x≤1, g(x)=1−a₁+(3a₁−2)x+2(1−a₁)x².

10. An embodiment as recited in claim 3, wherein the resistance taper of said Pgc is h(x), such that:
a. h(0)=0; h(0.5)=0.5; h(1)=1; and
b. the first derivative with respect to x of h(0) equals the first derivative with respect to x of h(1) and is greater than or equal to zero; and
c. h(x) has symmetry, such that the line between h(0.5−u) and h(0.5+u), 0≤u≤0.5, always passes through h(0.5)=0.5; and
d. nowhere between 0≤x≤1 may the first derivative of h(x) with respect to x be less than zero; and
e. the parameters defining h(x), in combination with the values of said Re and said R_{F}, are used to minimize the amplitude variations of the output of said summer/compensator op-amp, U3, with the rotation, x, of said 3-gang pot.

11. An embodiment as recited in claim 3, wherein the resistance taper of said Pgc is h(x), with a single fitting parameter, a₁, such that:
a. for 0≤x≤0.5, h(x)=a₁x+2(1−a₁)x²; and
b. for 0.5≤x≤1, h(x)=a₁−1+(4−3a₁)x+2(a₁−1)x²; and
c. said fitting parameter, a₁, in combination with the values of said Re and said R_{F}, is used to minimize to minimize the amplitude variations of the output of said summer/compensator op-amp, U3, with the rotation, x, of said 3-gang pot.

12. An embodiment as recited in claim 3, wherein the resistance taper of said Pgc is a piecewise linear function, h(x), which is determined by the known amplitudes of said two input signals to said summer/compensator at three or more points such that the output of said U3 tends to a single amplitude, Voset, over the entire rotation, x, of said three-gang pot, and:
a. said known amplitudes are determined by the actions of said circuit involving said Pga and said Pgb upon known combinations of said two input signals, and
b. x₀=h(x₀)=0, xₙ=h(xₙ)=1, and interior points for h(xᵢ), 0<xᵢ<1, 0≤i≤n, n>2, define the end points of said piecewise linear segments of h(x); and
c. said fixed resistances in said Re and said RF, along with said known points in h(x) are used to fit the output of said U3 to said Voset at said known points almost exactly, within the physical tolerances of the components used.

13. (If this is allowable, I am uncertain as to how to proceed on this Claim, and request the Examiner's help) A method of fitting parameters in the embodiment as recited in claim 12, so as to make the outputs of said summer/compensator using said U3 almost exactly equal to said Voset for said known input signals, including signals derived from humbucking pairs of sensors matched for hum response, comprised of:
a. a table containing:
i. fixed points of the fractional pot rotations, xᵢ, which are associated with known and measured combinations of said two input signals, due to the actions of multiplying said input signals by said pseudo-sine and -cosine functions, Q(xᵢ) and R(xᵢ); and
ii. the amplitudes of said known signal combinations, Vhbᵢ, which are different due to repeatable phase cancellations of the said two input signals, multiplied respectively the values of said QRrad of said pseudo-sine and -cosine functions, Q(xᵢ) and R(xᵢ), obtaining a multiplied amplitude, QRVhbᵢ,; and
iii. a set of desired gains, Gnᵢ, for each said signal combination, obtained by dividing said desired output level, Voset, by one-half of said multiplied amplitudes, QRVhbᵢ; and
iv. a set of values for h(xᵢ)(1−h(xᵢ)), calculated by solving the feedback equation for the feedback circuit using said U3 in said summer/compensator, using only the values of said resistances Rs, Re and R_{F}, the desired output, Voset, the desired gains, Gnᵢ, and said multiplied amplitudes, QRVhbᵢ; and
v. a set of fitting values, hfitᵢ, used only to calculate hfitᵢ(1−hfitᵢ); and
vi. a set of fitting errors, hferrᵢ=hfitᵢ(1−hfitᵢ)−h(xᵢ)(1−h(xᵢ)); and
vii. a set of gains, Gainᵢ, calculated solely from the feedback circuit values, with hfitᵢ which is used to calculate the resistances of said pot gang, Pgc, at rotational values xᵢ; and
viii. a calculated output signal level, Voᵢ, by multiplying Gainᵢ times QRVhbᵢ; and
b. minimizing each hferrᵢ by varying each associated hfitᵢ until hferrᵢ is effectively zero; and
c. using said resulting hfitᵢ values as the end points of said piecewise linear sections of said h(x).

14. A embodiment as recited in claim 12, when said Re is comprised of a single fixed resistor, R1, connected in series with said pot gang, Pgc, and there are known signal points at x=0, ½, and 1, whereby;
a. for x=0 or x=1, said desired gain is Gn₀, and said Re equals said R₁, the value of said R_{F} is put solely in terms of the value of said R₁ and said desired gain, Gn₀, according to the feedback circuit in use; and
b. for x=½, and said desired gain is Gn_{0.5}, the value of said resistor R₁ is then put solely in terms of the total resistance of said pot gang, Pgc and said gains, Gn₀ and Gn_{0.5}, according to the feedback circuit in use.

15. An embodiment as recited in claim 1, wherein two or more said modules using said three-gang pots are combined or cascaded, so that a number J>2 of said input signals can be linearly combined into one output, such that in a vector space, (S₁, S₂, . . . S_{J}), where the Sᵢ are the effective multipliers of said input signals at said output, can be normalized to 0≤Sᵢ≤1, and the value of SQRT(S₁²+S₂² . . . +S_{J}²) tends to 1.

16. An embodiment as recited in claim 15, wherein said summer/compensator parts of said modules act together and tend to keep the final output at a fixed amplitude, regardless of the values of said space dimensions, Sᵢ.

17. An embodiment as recited in claim 1, wherein said mechanical pot gangs are replaced by digital pots, as in FIG. 31, driven by a programmable processor, having the four basic math functions in its math processing unit, add, subtract, multiply and divide, in which the programming in said processor generates the pseudo-cosine function, designated in the Specification as R(x) or apcos(x), and a pseudo-sine function, designated in the Specification as Q(x) or apsin(x), where 0≤x≤1 is the full rotation of a virtual pot, and 0≤x≤2 is a full cycle of apcos(x) or apsin(x), by one of two methods:
a. a first method being a piecewise polynomial in second power of x, with a fitting parameter, a₁, using the form f(x)=2a₁x+2(1−a₁)x², and having values in four quarter-cycles, from 0 to 0.5, from 0.5 to 1, from 1 to 1.5, and from 1.5 to 2, as follows:
i. for 0≤x≤0.5, apcos(x) 32 1−2f(x) and apsin(x)=2(2x−f(x)); and
ii. for 0.5≤x≤1, apcos(x)=2f(1−x)−1 and apsin(x)=2(2(1−x)−f(1−x)); and
iii. for 1≤x≤1.5, apcos(x)=2f(x−1)−1 and apsin(x)=2(f(x−1)−2(x−1)); and
iv. for 1.5≤x≤2, apcos(x)=1−2f(2−x) and apsin(x)=2(f(2−x)−2(2−x)); and
b. a second method being a piecewise polynomial in fourth power of x, with a fitting parameter, a₂, using the form f(x)=1+a₂x²−(16+4a₂)x⁴, and having values in four quarter-cycles, from 0 to 0.5, from 0.5 to 1, from 1 to 1.5, and from 1.5 to 2, as follows:
i. for 0≤x≤0.5, apcos(x)=f(x) and apsin(x)=f(0.5=x); and
ii. for 0.5≤x≤1, apcos(x)=−f(1−x) and apsin(x)=f(x−0.5); and
iii. for 1≤x≤1.5, apcos(x)=−f(x−1) and apsin(x)=−f(1.5−x); and
iv. for 1.5≤x≤2, apcos(x)=f(2−x) and apsin(x)=−f(x−1.5).

18. An embodiment as recited in claim 2, wherein said Pgb is a digital pot with its low end connected to said signal ground, it high end connected to said second input signal, its wiper connected to said Buff2, and a programmable processor determines its taper and function, such that for the virtual pot rotation, 0≤x≤0.5, the wiper proceeds from said low end to said high end, and for 0.5≤x≤1, the wiper proceeds from said high end back down to said low end, said path from low to high to low producing said necessary function, R(x).

19. (Independent) A method of calculating approximate sines and cosines, designated as apsin(x) and apcos(x), respectively, in a programmable processor, having the four basic math functions in its math processing unit, add, subtract, multiply and divide, where 0≤x≤2 is a full cycle of apcos(x) or apsin(x), by one of two methods:
a. a first method being a piecewise polynomial in second power of x, with a fitting parameter, a₁, using the form f(x)=2a₁x+2(1−a₁)x², and having values in four quarter-cycles,0 from 0 to 0.5, from 0.5 to 1, from 1 to 1.5, and from 1.5 to 2, as follows:
i. for 0≤x≤0.5, apcos(x)=1−2f(x) and apsin(x)=2(2x−f(x)); and
ii. for 0.5≤x≤1, apcos(x)=2f(1−x)−1 and apsin(x)=2(2(1−x)−f(1−x)); and
iii. for 1≤x ≤1.5, apcos(x)=2f(x−1)−1 and apsin(x)=2(f(x−1)−2(x−1)); and
iv. for 1.5≤x≤2, apcos(x)=1−2f(2−x) and apsin(x)=2(f(2−x)−2(2−x)); and
b. a second method being a piecewise polynomial in fourth power of x, with a fitting parameter, a₂, using the form f(x)=1+a₂x²−(16+4a₂)x⁴, and having values in four quarter-cycles, from 0 to 0.5, from 0.5 to 1, from 1 to 1.5, and from 1.5 to 2, as follows:
i. for 0≤x≤0.5, apcos(x)=f(x) and apsin(x)=f(0.5−x); and
ii. for 0.5≤x≤1, apcos(x)=−f(1−x) and apsin(x)=f(x−0.5); and
iii. for 1≤x≤1.5, apcos(x)=−f(x−1) and apsin(x)=−f(1.5−x); and
iv. for 1.5≤x≤2, apcos(x)=f(2−x) and apsin(x)=−f(x−1.5).

20. An embodiment as recited in claim 1, wherein any of said Pga, Pgb or Pgc may be either an electromechanical pot gang, or a separate digital pot driven by a programmable processor.
